(19) United States
(12) Patent Application Publication
(10) Pub. No.: US 2025/0253751 A1
(43) Pub. Date: Aug. 7, 2025

(54) METHOD FOR OPERATING A PLANAR DRIVE SYSTEM AND PLANAR DRIVE SYSTEM

(71) Applicant: Beckhoff Automation GmbH, Verl (DE)

(72) Inventors: Dominik Sensen, Herzogenrath (DE); Viktor Balzer, Herford (DE); Johannes Beckhoff, Schloß Holte-Stukenbrock (DE); Manuel Bettenworth, Wien (AT); Jan Achterberg, Duisburg (DE)

(21) Appl. No.: 19/187,282

(22) Filed: Apr. 23, 2025

Related U.S. Application Data
(63) Continuation of application No. PCT/EP2023/079284, filed on Oct. 20, 2023.

(30) Foreign Application Priority Data
Nov. 8, 2022 (DE) 10 2022 129 508.7

(51) Int. Cl. H02K 41/03; H02P 6/00

(52) U.S. Cl. CPC H02K 41/031; H02P 6/006; H02K 2201/18

(57) ABSTRACT

A planar drive system includes first and second planar drive partial systems. A rotor is movable above a first stator surface in at least two directions, with the aid of first drive elements. The rotor has rotor drive elements for this purpose. The first planar drive partial system also includes a first controller with which the first drive elements can be actuated. The rotor can be moved above the second stator surface in at least two directions with the aid of second drive elements, if the rotor is arranged above the second stator surface. The second planar drive partial system further includes a second controller with which the second drive elements can be actuated. The first stator surface is adjacent to the second stator surface. In a transition area, the rotor is driven cooperatively by the first planar drive partial system and by the second planar drive partial system.

### CROSS-REFERENCE TO RELATED APPLICATIONS

This application is a continuation of International Patent Application PCT/EP2023/079284, filed Oct. 20, 2023, entitled “Method for Operating a Planar Drive System and Planar Drive System,” which claims priority to German patent application DE 10 2022 129 508.7, filed Nov. 8, 2022, entitled “Verfahren zum Betreiben eines Planarantriebssystems und Planarantriebssystem,” each of which is incorporated by reference herein, in the entirety and for all purposes.

### FIELD

The invention relates to a method for operating a planar drive system and to a planar drive system.

### BACKGROUND

Planar drive systems may be used in automation technology, in particular production technology, handling technology, process engineering, packaging technology and printing technology. Planar drive systems may be used to move or position a moving element of a system or machine in at least two linearly independent directions. Planar drive systems may comprise a permanently energized electromagnetic planar motor with a planar stator and a rotor that may move on the stator in at least two directions.

In a permanently energized electromagnetic planar motor, a drive force is exerted upon the rotor by the fact that energized coil arrangements of a stator module interact magnetically with drive magnets of a plurality of magnet arrangements of the rotor. Coil arrangements may be combined to form stator assemblies, and the stator module may comprise a plurality of such stator assemblies. Planar drive systems with rectangular and longitudinally stretched coil arrangements and rectangular and longitudinally stretched magnet arrangements of the rotor are known from the prior art. Such a planar drive system is described, for example, in publication DE 10 2017 131 304 A1. With the aid of such a planar drive system, a linear and translative movement of the rotor is particularly. This means that with the aid of such a planar drive system, the rotor may be moved freely in parallel to the stator surface above a stator surface, under which the rectangular and elongated coil arrangements are arranged, and may be moved perpendicular with regard to the stator surface at least at different distances from the stator surface. Furthermore, such a planar drive system is able to tilt the rotor by a few degrees and rotate it by a few degrees. The latter movements may be carried out above any points on the stator surface. In particular, the rotor may be rotated by up to 20° from a normal position.

An alternative technical embodiment of a planar drive system is disclosed in publications DE 10 2016 224 951 A1 and DE 10 2018 209 403 A1. In this planar drive system, controlled transportation of a rotor relative to a stator is rendered possible by the fact that one of the two elements comprises a plurality of at least partially movably arranged actuating magnets, the respective position and/or orientation of which relative to this element may be predetermined in a controlled manner via actuating elements, and the other of the two elements comprises at least two stationary magnets immovably connected to this element, the stationary magnets being magnetically coupled to actuating magnets. The planar drive system is embodied to move the rotor relative to the stator by controlled positioning and/or orientation of the positioning magnets. In particular, the conveying comprises bringing the at least one rotor into a desired position and/or orientation relative to the stator. The movably arranged positioning magnets may serve as drive elements. Control variables for these drive elements may include, for example, rotation angles and/or rotation speeds of the movably arranged control magnets.

In the further description, a planar drive system according to publication DE 10 2017 131 304 A1 is initially assumed, wherein the essential features of the invention are also readily transferable to a planar drive system according to DE 10 2016 224 951 A1 or DE 10 2018 209 403 A1.

A controller is used in order to control a planar drive system in accordance with DE 10 2017 131 304 A1, which converts the specified trajectories of the rotors into current information for the coil arrangements and then controls the energization of the coil arrangements. The actual positions of the rotors determined with the aid of position sensors may be used to control the currents of the coil arrangements. Inputs to the planar drive system and outputs from the planar drive system are made via the controller. The controller may, for example, comprise a user interface such as a keyboard, a computer mouse and/or a screen for inputting and outputting information.

When controlling such a planar drive system, it has been found that the controller may only control a predetermined number of stator modules due to a finite computing capacity and may take into account the positions and movement paths of a predetermined number of rotors. For example, the controller may control one hundred stator modules and, for example, take into account the positions of forty rotors.

### SUMMARY

The invention provides an improved method for operating a planar drive system in which a larger number of stator modules and/or a larger number of rotors may be used. The invention further provide an improved planar drive system in which a larger number of stator modules and/or a larger number of rotors may be used.

### Examples

According to an aspect, a method operates a planar drive system. The planar drive system comprises a first planar drive partial system and a second planar drive partial system, wherein the first planar drive partial system comprises first stator modules forming a first stator surface, wherein the first stator modules comprise first drive elements and first position detectors, wherein the first planar drive partial system further comprises a first controller with the aid of which the first drive elements may be actuated, wherein the first controller is furthermore set up to read in first measured values of the first position detectors, wherein the second planar drive partial system comprises second stator modules which form a second stator surface, wherein the second stator modules comprise second drive elements and second position detectors, wherein the second planar drive partial system further comprises a second controller with the aid of which the second drive elements may be actuated, wherein the second controller is further arranged to read in second measured values of the second position detectors, wherein the first stator surface is adjacent to the second stator surface.

The planar drive system further comprises at least one rotor which is movable in at least two directions above the first stator surface and the second stator surface, respectively, with the aid of the first drive elements and the second drive elements wherein the method for operating the planar drive system allows for driving the rotor cooperatively with the aid of the first planar drive partial system and the second planar drive partial system. The method comprises the following steps:
triggering a drive cooperation based on a marginal condition via the first controller;
outputting a cooperation signal to the second controller via the first controller;
receiving the cooperation signal via the second controller;
outputting the second measured values to the first controller via the second controller;
receiving the second measured values via the first controller;
determining first rotor position data from the first measured values and the second measured values via the first controller;
comparing the first rotor position data with first rotor position target data and calculating a first actuating value for one of the first drive elements and/or calculating a second actuating value for one of the second drive elements on the basis of the comparison of the first rotor position data with the first rotor position target data via the first controller;
outputting the second actuating value to the second controller via the first controller if the second actuating value has been calculated;
receiving the second actuating value via the second controller;
operating the first drive element with the aid of the first actuating value calculated for the first drive element via the first controller; and
operating the second drive element with the aid of the second actuating value calculated for the second drive element via the second controller.

According to another aspect, a planar drive system comprises a first planar drive partial system and a second planar drive partial system, wherein the first planar drive partial system comprises first stator modules having first stator assemblies forming a first stator surface, wherein the first stator modules comprise first drive elements and first position detectors. The first planar drive partial system further comprises a first controller according to claim 17, wherein the second planar drive partial system comprises second stator modules having second stator assemblies forming a second stator surface, wherein the second stator modules comprise second drive elements and second position detectors. The second planar drive partial system further comprises a second controller according to claim 19, wherein the first stator surface is adjacent to the second stator surface, wherein the planar drive system further comprises at least one rotor which is movable in at least two directions above the first stator surface and the second stator surface, respectively, with the aid of the first drive elements and the second drive elements. The method for operating the planar drive system according to claims 1 to 15 allows for driving the rotor cooperatively with the first planar drive partial system and the second planar drive partial system.

According to another aspect, a method operates a planar drive system. The planar drive system comprises a first planar drive partial system and a second planar drive partial system, wherein the first planar drive partial system comprises first stator modules forming a first stator surface, wherein the first stator modules comprise first drive elements and first position detectors, wherein the first planar drive partial system further comprises a first controller with the aid of which the first drive elements may be actuated, wherein the first controller is furthermore set up to read in first measured values of the first position detectors, wherein the second planar drive partial system comprises second stator modules which form a second stator surface, wherein the second stator modules comprise second drive elements and second position detectors, wherein the second planar drive partial system further comprises a second controller with the aid of which the second drive elements may be actuated, wherein the second controller is further arranged to read in second measured values of the second position detectors, wherein the first stator surface is adjacent to the second stator surface.

The planar drive system further comprises at least one rotor which is movable in at least two directions above the first stator surface and the second stator surface, respectively, with the aid of the first drive elements and the second drive elements wherein the method for operating the planar drive system allows for driving the rotor cooperatively with the aid of the first planar drive partial system and the second planar drive partial system. The method comprises the following steps:
triggering a drive cooperation based on a marginal condition via the first controller;
outputting a cooperation signal to the second controller via the first controller;
receiving the cooperation signal via the second controller;
executing a first position control procedure and a second position control procedure,
wherein the first position control procedure comprises the following steps:
outputting the second measured values to the first controller via the second controller;
receiving the second measured values via the first controller;
determining first rotor position data from the first measured values and the second measured values via the first controller;
comparing the first rotor position data with first rotor position target data and calculating a first actuating value for one of the first drive elements and/or calculating a second actuating value for one of the second drive elements on the basis of the comparison of the first rotor position data with the first rotor position target data via the first controller;
outputting the second actuating value to the second controller via the first controller if the second actuating value has been calculated;
receiving the second actuating value via the second controller;
and wherein the second position control procedure comprises the following steps:
outputting the first measured values to the second controller via the second controller;
receiving the first measured values via the second controller;
determining second rotor position data from the second measured values and the first measured values via the second controller;
comparing the second rotor position data with second rotor position target data and calculating a first redundant actuating value for one of the first drive elements and/or calculating a second redundant actuating value for one of the second drive elements via the second controller;
outputting the first actuating value to the first controller via the second controller;
receiving the first actuating value via the first controller;
operating the first drive element with the aid of the first actuating value calculated for the first drive element via the first controller; and
operating the second drive element with the aid of the second actuating value calculated for the second drive element via the second controller.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a cross-section of a planar drive system.

FIG. 2 shows a top view of the planar drive system of FIG. 1.

FIG. 3 shows a further top view of the planar drive system of FIGS. 1 and 2.

FIG. 4 shows a flow chart of a method for operating a planar drive system.

FIG. 5 shows a further top view of the planar drive system of FIGS. 1, 2 and 3.

FIG. 6 shows a further top view of the planar drive system of FIGS. 1, 2, 3 and 5.

FIG. 7 shows a further flow chart of the method for operating the planar drive system with further optional steps.

FIG. 8 shows a further top view of the planar drive system of FIGS. 1, 2, 3, 5 and 6.

FIG. 9 shows a top view of a further planar drive system.

FIG. 10 shows a top view of a further planar drive system.

FIG. 11 shows a top view of a further planar drive system.

FIG. 12 shows a top view of a further planar drive system.

### DETAILED DESCRIPTION

A planar drive system comprises a first planar drive partial system and a second planar drive partial system. The first planar drive partial system comprises first stator modules that form a first stator surface. The first stator modules comprise first drive elements and first position detectors. The first planar drive partial system further comprises a first controller with the aid of which the first drive elements may be actuated and first measured values of the first position detectors may be read in. Furthermore, the first controller may be provided for evaluating the first measured values of the first position detectors and for determining rotor positions as a result. The second planar drive partial system comprises second stator modules that form a second stator surface. The second stator modules comprise second drive elements and second position detectors.

The second planar drive partial system further comprises a second controller with the aid of which the second drive elements may be actuated and second measured values of the second position detectors may be read in. Furthermore, the second controller may be provided for evaluating the second measured values of the second position detectors and for thereby determining rotor positions. The first controller and the second controller may be connected with the aid of a communication link and exchange data.

The first stator surface is adjacent to the second stator surface. In particular, this may mean that the first stator surface and the second stator surface are in contact. However, a gap may also be provided between the first stator surface and the second stator surface. The planar drive system also comprises at least one rotor, which may be moved in at least two directions above the first stator surface or of the second stator surface with the aid of the first drive elements and the second drive elements. In particular, the rotor may be driven by an interaction of the drive elements with rotor magnets.

The drive elements may comprise coil arrangements. Coil arrangements may be combined to form stator assemblies. The first stator module may comprise a plurality of first stator assemblies. The second stator module may comprise a plurality of second stator assemblies. The drive elements may be the coil groups described in publication DE 10 2017 131 304 A1. The rotor may comprise the magnet units described in this disclosure document. Alternatively, the drive elements may be the movably arranged positioning magnets described in the disclosure documents DE 10 2016 224 951 A1 and DE 10 2018 209 403 A1. The rotor may comprise the immovable magnets described in these disclosure documents.

A method operates such a planar drive system which allows for the rotor to be driven cooperatively with the first planar drive partial system and the second planar drive partial system. For this purpose, the method for operating the planar drive system comprises the following steps:
triggering a drive cooperation based on a marginal condition via the first controller;
outputting a cooperation signal to the second controller via the first controller;
receiving the cooperation signal via the second controller;
outputting the second measured values to the first controller via the second controller;
receiving the second measured values via the first controller;
determining first rotor position data from the first measured values and from the second measured values via the first controller;
comparing the first rotor position data with first rotor position target data and calculating a first actuating value for one of the first drive elements and/or calculating a second actuating value for one of the second drive elements on the basis of the comparison of the first rotor position data with the first rotor position target data via the first controller;
outputting the second actuating value to the second controller via the first controller if the second actuating value has been calculated;
receiving the second actuating value via the second controller;
operating of the first drive element with the aid of the first actuating value calculated for the first drive element via the first controller; and
operating of the second drive element with the aid of the second actuating value calculated for the second drive element via the second controller.

Instead of calculating a first actuating value, a plurality of first actuating values may also be calculated for a plurality of the first drive elements. As the case may be, a first actuating value may be calculated for all first drive elements. Instead of calculating a second actuating value, a plurality of second actuating values may also be calculated for a plurality of the second drive elements. As the case may be, a second actuating value may be calculated for all second drive elements. In the following, it may always be assumed that a plurality of actuating values is provided for a formulation selected as the actuating value or vice versa.

The method for operating a planar drive system is based on the idea that the first planar drive partial system and the second planar drive partial system may in principle control rotors autonomously. However, for certain operating states, for example when a rotor is to be moved in a limit range between the first planar drive partial system and the second planar drive partial system, the rotor is driven cooperatively. To make this possible, the first controller is in this method responsible for controlling the rotor. However, the second controller provides the second measured values from the second position detectors. This allows for the first controller to determine the exact position of the rotor, even if the rotor is already at least partially above the second stator surface, for example.

The second actuating value is calculated in particular when a second drive element is required to drive the rotor. This may be assessed using the rotor position, for example. In particular, if the second actuating value is not equal to zero, the second actuating value is required to drive the rotor. In this case, the second drive element must be operated in such a way that a transmission of the corresponding second actuating value is also required. The same also applies if more than one second drive element needs to be operated and therefore more than one second actuating value needs to be transmitted. By outputting the second actuating value to the second controller, the latter is also able to operate the second drive element or the second drive elements in such a way that the rotor may also be driven by the second drive element or by the second drive elements. The second controller therefore does not carry out its own control, but operates the second drive element or elements exclusively according to the second control variables received.

If the second actuating values are not required to actuate the rotor, for example if the rotor is completely above the first stator surface, it may be provided that the second actuating values are nevertheless calculated and output via the first controller. Furthermore, it may be provided that the first controller outputs corresponding information in this case, on the basis of which the second controller recognizes that the second actuating values are not required to actuate the rotor and therefore none were calculated. This may save transmission capacity.

In particular, the marginal condition may include a rotor approaching a transition region between the first stator surface and the second stator surface. For example, the marginal condition could be that the rotor is less than a predetermined distance from a boundary between the first planar drive partial system and the second planar drive partial system. Furthermore, as an alternative or in addition, the marginal condition may include that a rotor is to be transferred from the first planar drive partial system to the second planar drive partial system. The drive cooperation then makes it possible to operate the first drive elements or second drive elements cooperatively and thus provide a common drive of the rotor via both planar drive partial systems. Furthermore, it may be provided that the first controller may only trigger the drive cooperation when the rotor is located above the first stator surface.

A method for operating a first controller of a planar drive system comprises the following steps:
triggering a drive cooperation based on a marginal condition;
outputting a cooperation signal to a second controller;
receiving of the second measured values via the first controller;
determining the first rotor position data from the first measured values and the second measured values;
receiving the second measured values from the second controller;
comparing the first rotor position data with first rotor position target data and calculating a first actuating value for one of the first drive elements and/or calculating a second actuating value for one of the second drive elements on the basis of the comparison of the first rotor position data with the first rotor position target data;
outputting the second actuating variable to the second controller if the second actuating variable has been calculated; and
operating the first drive element with the first actuating value calculated for the first drive element.

The method for operating the first controller therefore includes all the method steps of the method for operating the planar drive system, which are carried out via the first controller. In particular, the calculations regarding the rotor position and operation of the drive element(s) are carried out via the first controller.

A first controller for a first planar drive partial system is arranged to carry out the method for operating the first controller.

A method for operating a second controller of a planar drive system comprises the following steps:
receiving a cooperation signal;
outputting the second measured values to the first controller;
receiving a second actuating value; and
operating the second drive element with the second actuating value calculated for the second drive element via the second controller.

The method for operating the second controller therefore includes all the method steps of the method for operating the planar drive system, which are carried out via the second controller. In particular, the second controller forwards the second measured values to the first controller and receives the second actuating value for the second drive element and operates this with the second actuating value.

A second controller for a second planar drive partial system is arranged to carry out the method for operating the second controller.

A planar drive system comprises a first planar drive partial system and a second planar drive partial system. The first planar drive partial system comprises first stator modules having first stator assemblies forming a first stator surface. The first stator modules comprise first drive elements and first position detectors. The first planar drive partial system further comprises the first controller according to the third aspect of the invention, with the aid of which the first drive elements may be actuated. Furthermore, the first controller may be provided for evaluating the first position detectors and thereby determining rotor positions. The second planar drive partial system comprises second stator modules with second stator assemblies that form a second stator surface. The second stator modules comprise second drive elements and second position detectors. The second planar drive partial system further comprises the second controller according to the fifth aspect of the invention, with the aid of which the second drive elements may be actuated. Furthermore, the second controller may be provided for evaluating the second position detectors and thereby determining rotor positions.

The first controller and the second controller may be connected with the aid of a communication link and exchange data. The first stator surface is adjacent to the second stator surface. In particular, this may mean that the first stator surface and the second stator surface are in contact. However, a gap may also be provided between the first stator surface and the second stator surface. The planar drive system also comprises at least one rotor that may be moved in at least two directions above the first stator surface or the second stator surface with the aid of the first drive elements and the second drive elements. The drive elements may be the coil groups described in publication DE 10 2017 131 304 A1. The rotor may comprise the magnet units described in this publication. As an alternative, the drive elements may be the movably arranged positioning magnets described in the disclosure documents DE 10 2016 224 951 A1 and DE 10 2018 209 403 A1. The rotor may comprise the immovable magnets described in these disclosure documents.

The method steps relating to the first controller or the second controller, respectively, may in each case also be provided optionally in the method for operating the first controller or in the method for operating the second controller. It may be provided in each case that a single first actuating value is calculated and used accordingly. As an alternative, a plurality of first actuating values may be calculated and used in each case. The same applies to the second actuating values. If an individual actuating value is mentioned in the following, the descriptions should always apply analogously to a plurality of the corresponding actuating values and vice versa.

In the method for operating the planar drive system, the steps of outputting the second measured values to the first controller via the second controller;
receiving the second measured values via the first controller;
determining first rotor position data from the first measured values and the second measured values via the first controller;
comparing the first rotor position data with first rotor position target data and calculating a first actuating value for one of the first drive elements and/or calculating a second actuating value for one of the second drive elements via the first controller;
outputting the second actuating value to the second controller via the first controller if the second actuating value has been calculated;
receiving the second actuating value via the second controller;
operating the first drive element with the first actuating value calculated for the first drive element via the first controller; and
operating the second drive element with the second actuating value calculated for the second drive element via the second controller;
are repeated cyclically.

This cyclic repetition may e.g. be carried out with a predetermined cycle time, wherein the predetermined cycle time is less than one millisecond, in particular less than half a millisecond, and may e.g. be 250 microseconds. With a cycle time in this range, for example, the first controller of the first planar drive partial system may actuate one hundred first stator modules and forty rotors above the first stator surface. The second controller of the second planar drive partial system may actuate one hundred second stator modules and forty rotors above the second stator surface.

In the method of operating the planar drive system, the following steps are further carried out:
outputting the first measured values to the second controller via the first controller;
receiving the first measured values via the second controller;
determining second rotor position data from the second measured values and the first measured values via the second controller;
comparing the second rotor position data with second rotor position target data and calculating a first redundant actuating value for one of the first drive elements and/or calculating a second redundant actuating value for one of the second drive elements via the second controller;
outputting the first redundant actuating value to the first controller via the second controller; and
receiving the first redundant actuating value via the first controller.

This allows for a rotor position to be calculated by both the first controller and the second controller. Furthermore, the first actuating value or the second actuating value is calculated via the first controller and the first redundant actuating value or second redundant actuating value is calculated via the second controller. This allows for transferring control of the rotor from the first controller to the second controller, as the case may be. In particular, this redundant calculation means that the second controller may take over control of the rotor without any significant delay, as all relevant information is already available to the second controller by calculating the first redundant actuating value or second redundant actuating value. This may, for example, allow for a planar drive system and an operating method of such a system in which rotors are transferred from the first planar drive partial system to the second planar drive partial system. Furthermore, this also makes it possible to detect errors in the calculating the actuating values, since in the event that the first actuating value deviates from the first redundant actuating value or the second actuating value deviates from the second redundant actuating value, it may not be possible to transfer control of the rotor from the first controller to the second controller. In this case, control may, for example, be left with the first controller until the actuating values match their redundant actuating values.

In the method for operating the planar drive system, the cooperation signal is a transfer signal. After receiving the transfer signal, the second controller checks whether a rotor transfer is possible. If a rotor transfer is possible, a confirmation is sent to the first controller. If a rotor transfer is not possible, an error message is sent to the first controller. This allows the second controller to reject the rotor transfer or approve the rotor transfer. In particular, it may be taken into account whether the second controller is able to exercise control over the rotor and calculate the control variables accordingly. In particular, these steps may be carried out via the second controller.

In the method for operating the planar drive system, the second controller checks whether a rotor transfer is possible by evaluating a free computing capacity of the second controller. This may be done, for example, according to a current CPU utilization and/or memory utilization. Furthermore, a number of possible rotors may also be specified, for example the number of forty rotors mentioned above. If a further rotor may be checked according to these criteria, the confirmation is issued, otherwise the error message is issued. These steps may be carried out via the second controller in particular.

In the method for operating the planar drive system, a rotor transition from the first planar drive partial system to the second planar drive partial system and a control transition from the first controller to the second controller take place. After the control transition, the following steps are performed:
outputting the first measured values to the second controller via the first controller;
receiving the first measured values via the second controller;
determining second rotor position data from the first measured values and the second measured values via the second controller;
comparing the second rotor position data with second rotor position target data and calculating a first actuating value for one of the first drive elements and/or calculating a second actuating value for one of the second drive elements via the second controller;
outputting the first actuating value to the first controller via the second controller if the first actuating value has been calculated;
receiving the first actuating value via the first controller;
operating the first drive element with the first actuating value calculated for the first drive element via the first controller; and
operating the second drive element with the second actuating value calculated for the second drive element via the second controller.

After the control transition, the calculations required in order to actuate the drive elements are therefore carried out via the second controller. The first controller provides the measured values from the first position sensors for this purpose and receives the first actuating value from the second controller. This method may therefore be used to switch between the planar drive partial systems. Here, too, the second controller may calculate a plurality of first actuating values and/or a plurality of second actuating values and output the plurality of second actuating values to the first controller. The first actuating value or the first actuating values are calculated in particular when they are required to drive the rotor.

In the method for operating the planar drive system, the steps of:
outputting the first measured values to the second controller via the first controller;
receiving the first measured values via the second controller;
determining second rotor position data from the second measured values and the first measured values via the second controller;
comparing the second rotor position data with second rotor position target data and calculating a first actuating value for one of the first drive elements and/or calculating a second actuating value for one of the second drive elements via the second controller;
outputting the first actuating value to the first controller via the second controller if the first actuating value has been calculated;
receiving the first actuating value via the first controller;
operating the first drive element with the first actuating value calculated for the first drive element via the first controller; and
operating the second drive element with the second actuating value calculated for the second drive element via the second controller;
are repeated cyclically.

This cyclical repetition may also be carried out with a specified cycle time, for example, as described above.

In the method of operating the planar drive system, the method further comprises the following steps carried out after the control transition:
outputting the second measured values to the first controller via the second controller;
receiving the second measured values via the first controller;
determining first rotor position data from the first measured values and the second measured values via the first controller;
comparing the first rotor position data with first rotor position target data and calculating a first redundant actuating value for one of the first drive elements and/or calculating a second redundant actuating value for one of the second drive elements via the first controller;
outputting the second redundant actuating value to the second controller via the first controller; and
receiving the second redundant actuating variable via the second controller.

The first controller may therefore continue to calculate the corresponding control variables redundantly. This may continue until the rotor transfer is complete. In particular, a termination signal may be provided for the first controller to signal to the first controller that the rotor transfer has been completed. The termination signal may be generated via the second controller, for example, if the second controller recognizes that neither measured values of the first rotor position data are required any further, nor the first drive elements are required to drive the rotor. In this case, the second controller may output the termination signal to the first controller. The first controller receives the termination signal and sets the transmission of the first measured values of the first position detectors.

In the method for operating the planar drive system, rotor-specific data are transmitted between the first controller and the second controller. The rotor-specific data may include, for example, a mass and/or a load and/or information about objects arranged on the rotor. The rotor-specific data may also include a designation for the rotor and/or specific control settings to be used for the rotor.

It may be provided that the planar drive system comprises a central controller. In particular, the central controller may be set up to provide control of the entire planar drive system, wherein the central controller considers current rotor positions and also outputs target positions for the rotors to the first controller or the second controller. However, the actuating values of the drive elements required for the movement from the current rotor positions to the target position of the rotor are still calculated via the first controller or the second controller.

In an embodiment of the method for operating the planar drive system, the central controller receives first rotor position data from the first controller and second rotor position data from the second controller. The central controller also issues a cooperation command to the first controller, the cooperation command being a marginal condition. In this case, the central controller therefore instructs the first controller to carry out the drive cooperation and output the cooperation signal. For example, the central controller may use the first rotor position data or second rotor position data to recognize that drive cooperation is necessary, for example because a rotor transfer is to take place. This may be communicated to the first and/or second controllers so that they carry out the steps necessary for the method according to the invention.

In the method for operating the planar drive system, the central controller inquires from the second controller whether a rotor transfer is possible. The second controller checks whether a rotor transfer is possible, wherein a confirmation is issued to the central controller if a rotor transfer is possible and an error message is issued to the central controller if a rotor transfer is not possible. It may then be provided that the central controller issues a corresponding cooperation command to the first controller. It may be provided that the first controller nevertheless outputs the transfer signal as a cooperation signal. In this case, it may be provided that the second controller does not carry out any further check as to whether a rotor transfer is possible.

In the method for operating the planar drive system, it may be provided that the central controller uses the first rotor position data and the second rotor position data to recognize that the rotor transfer has been completed and outputs a termination signal to the first controller and/or the second controller.

In the method for operating the planar drive system, the central controller issues a control transfer command to the first controller and/or to the second controller. A control transition is carried out using the control transfer command. This may take place, for example, if the central controller recognizes that a control transfer and a rotor transfer are necessary if the rotor is to reach a target position.

In the method for operating the planar drive system, the central controller outputs first rotor position target data to the first controller and/or second rotor position target data to the second controller. The first controller may calculate the actuating values using the first rotor position target data. The second controller may calculate the actuating values using the second rotor position target data. In this case, the central controller controls the positions of the rotors of the planar drive system.

In the method for operating the planar drive system, rotor-specific data are transmitted between the central controller and the first controller or the second controller. The rotor-specific data may correspond to the rotor-specific data described above.

In the method of operating the planar drive system, drive cooperation is started when a rotor is within a predetermined distance with regard to an edge region of the first planar drive partial system.

In the following, the same reference numerals may be used for identical features. Furthermore, for reasons of clarity, it may be the case that not all elements are shown in every figure. Furthermore, for the sake of clarity, it may be the case that not every element is provided with its own reference numeral in every drawing.

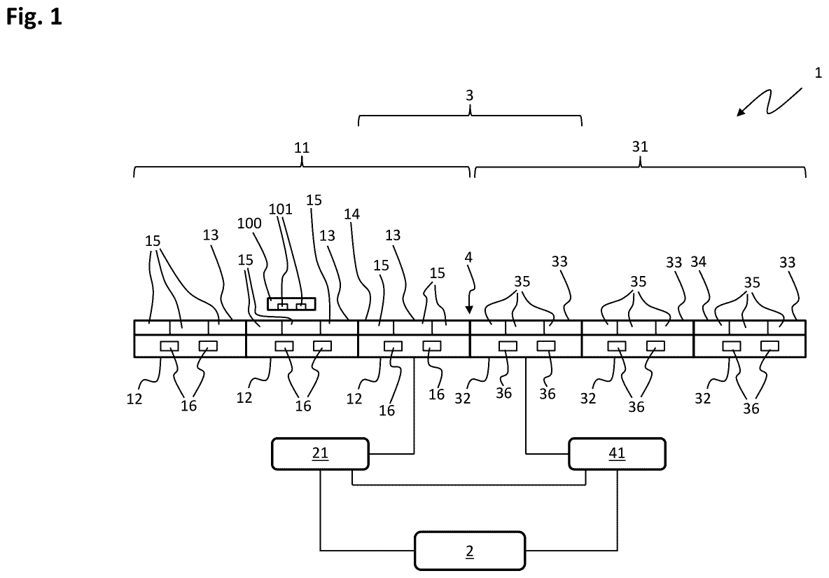

FIG. 1 shows a planar drive system 1 having a first planar drive partial system 11 and a second planar drive partial system 31. The first planar drive partial system 11 comprises first stator modules 12. Optionally, first stator assemblies 13 are provided, which are arranged in the first stator modules 12. The first stator modules 12 form a first stator surface 14. The first stator modules 12 comprise first drive elements 15 and first position detectors 16.

The first drive elements 15 may be the coil groups described in publication DE 10 2017 131 304 A1. In particular, the drive elements 15 may each comprise an energizable three-phase system. An electromagnetic traveling field may then be generated with the aid of the first drive elements 15. Alternatively, the drive elements may be the movably arranged positioning magnets described in the disclosure documents DE 10 2016 224 951 A1 and DE 10 2018 209 403 A1. The rotor may comprise the immovable magnets described in these disclosure documents. The first position detectors 16 may, for example, be magnetic field sensors, in particular Hall sensors, in particular 3D Hall sensors.

A possible arrangement of the first position detectors 16 in the first stator modules may be taken, for example, from the disclosure DE 10 2017 131 320 A1. In particular, it may be provided that a plurality of first position detectors 16 are provided within a first stator module 12, in particular more than twenty first position detectors 16 and preferably more than forty first position detectors 16. The first position detectors 16 may in particular be embodied as magnetic field sensors. Here, the first position detectors 16 are arranged on a sensor module. The sensor module comprises a carrier and a two-dimensional arrangement of magnetic field sensors, each magnetic field sensor corresponding to one of the first position detectors 16. The magnetic field sensors are arranged on the carrier.

The two-dimensional arrangement of magnetic field sensors comprises a first partial arrangement of magnetic field sensors and a second partial arrangement of magnetic field sensors. The magnetic field sensors of the first partial arrangement are arranged in a first periodic grid. The magnetic field sensors in the first periodic grid are arranged along a first direction and along a second direction. Adjacent magnetic field sensors of the first partial arrangement in the first direction are arranged at a first distance from one another. Adjacent magnetic field sensors of the first partial arrangement in the second direction are arranged at a second distance from one another. The magnetic field sensors of the second partial arrangement are arranged in a second periodic grid. The magnetic field sensors in the second periodic grid are arranged along the first direction and along the second direction. Adjacent magnetic field sensors of the second partial arrangement are arranged in the first direction at a first distance from one another and in the second direction at a second distance from one another.

The first partial arrangement and the second partial arrangement are arranged at an offset with regard to each other by a vector. The vector comprises a first component in the first direction and a second component in the second direction. The first component is smaller than the first distance. The second component is smaller than the second distance. As the rotor drive element 101, the rotor 100 comprises, for example, a first magnet unit with a first periodic arrangement of magnets with a first period length. Furthermore, the rotor 100 comprises a second magnet unit with a second periodic arrangement of magnets with a second period length. The first periodic arrangement of magnets is periodic in the first direction. The second arrangement of magnets is periodic in the second direction.

During operation of the planar drive system 1, the first magnet unit is aligned in the first direction and the second magnet unit is aligned in the second direction. The first component is smaller than the first period length. A difference between the first distance and the first component is also smaller than the first period length. The second component is smaller than the second period length. A difference between the second distance and the second component is also smaller than the second period length. In order to detect the position of the rotor 100 in the planar drive system 1 from the individual measured values of the position detectors, it is necessary for a sufficiently large number of magnetic field sensors to be provided within the sensor module. This makes it possible to always have a sufficient number of magnetic field sensors available in the vicinity of the rotor 100 in order to be able to determine the exact position of the rotor 100.

On the other hand, the measurement data from the magnetic field sensors must be evaluated, which is why the smallest possible number of magnetic field sensors should be provided, as this may reduce the computing power required. By arranging the magnetic field sensors of the position detection unit in two periodic grids, wherein the grids have an identical structure and are shifted relative to each other, sufficient magnetic field sensors are provided on the one hand to be able to determine the position of the rotor 100. On the other hand, the number of magnetic field sensors is so small that the computing power required for the evaluation during the detection of the position of the rotor 100 is reduced. DE 10 2020 115 449 A1 also discloses a method in which position detectors of adjacent stator modules may be used to detect the position of a rotor 100.

Here, among other things, a sensor pattern of the magnetic field sensors of the sensor module is determined in a sensor pattern determining step, wherein a sensor pattern comprises a subset of the magnetic field sensors of the sensor module of the stator module. This achieves the technical advantage that a method for controlling a planar drive system 1 may be provided in which only relevant magnetic field sensors of the sensor module of the stator module are selected for determining the position of the rotor 100 on the stator module of the planar drive system 1. Of course, this also applies when the rotor 100 is transferred from one stator module to another stator module and, in particular, when it is transferred from one planar drive partial system to another planar drive partial system. In particular, such a method may be used to select the position detectors from which measured values are transmitted from one controller to another controller, which reduces the overall amount of data to be transmitted. With regard to the structure and mode of operation of the position detection with the aid of the position detectors, reference is made in particular to DE 10 2017 131 320 A1 and DE 10 2020 115 449 A1, the content of which is incorporated in full into the present application by reference.

The planar drive system 1 further comprises at least one rotor 100, which, with the aid of the first drive elements 15, may be moved above the first stator surface 14 in at least two directions parallel to the first stator surface 14. Furthermore, it may also be provided that the rotor 100 may be moved perpendicular with regard to the first stator surface 14, may be tilted relative to the first stator surface 14 and may be rotated about an axis perpendicular with regard to the first stator surface 14. In FIG. 1, the rotor 100 is arranged above the first stator surface 14. In particular, the rotor 100 comprises rotor drive elements 101 for this purpose.

The rotor drive elements 101 may be embodied as permanent magnets and arranged as described in publication DE 10 2017 131 304 A1. The first planar drive partial system 11 also comprises a first controller 21 with the aid of which the first drive elements 15 may be actuated. In particular, the first controller 21 may be set up to determine first actuating values for the first drive elements 15 and to output them to the first drive elements 15. In addition, the first controller 21 is set up to read in first measured values from the first position detectors 16. Furthermore, the first controller 21 may be provided for evaluating the first measured values of the first position detectors 16 and thereby determining rotor positions, in particular a position of the rotor 100. This may be done, for example, by evaluating a magnetic field of the rotor drive elements 101, in particular if the rotor drive elements 101 are embodied as permanent magnets and the first position detectors 16 comprise Hall sensors.

In particular, the first actuating values may be forces that are to act upon the rotor 100. The first drive elements 15 may then be operated in such a way that the forces of the first actuating values act upon the rotor 100. Alternatively, the first actuating values may also directly comprise operating information of the first drive elements 15, for example a current for a first drive element 15 embodied as a drive coil or a rotational position or rotational speed for a first drive element 15 embodied as a movable magnet.

The first controller 21 is connected to one of the first stator modules 12 to provide a communication link between the first controller 21 and the respective first stator module 12. The first stator modules 12 may also be connected to each other. Alternatively, contrary to the depiction of FIG. 1, it is also conceivable that the first controller 21 is connected to each of the first stator modules 12.

The second planar drive partial system 31 comprises second stator modules 32 with second stator assemblies 33, which form a second stator surface 34. The second stator modules 33 comprise second drive elements 35 and second position detectors 36. The second drive elements 35 may be embodied analogously to the first drive elements 15. The second position detectors 36 may be embodied in the same way as the first position detectors 16. The rotor 100 may in principle also be moved above the second stator surface 34 in at least two directions with the aid of the second drive elements 35 if the rotor 100 is arranged above the second stator surface 34.

The second planar drive partial system 31 also comprises a second controller 41 which may be used to actuate the second drive elements 35. In addition, the second controller 41 is set up to read in second measured values from the second position detectors 16. Furthermore, the second controller 41 may be provided for evaluating the second measured values of the second position detectors 36 and thereby for determining rotor positions. In particular, this may be carried out analogously to the methods already described for the first controller 21. The arrangement of the second position detectors 36 in the second stator modules 32 may also be based on DE 10 2017 131 320 A1, as already described for the first stator modules 12. In particular, it may be provided that a plurality of second position detectors 36 is provided within a second stator module 32, in particular more than twenty second position detectors 36 and preferably more than forty second position detectors 36. The second position detectors 36 may in particular be embodied as magnetic field sensors.

The second controller 41 is connected to one of the second stator modules 32 to provide a communication link between the second controller 41 and the respective second stator module 32. The second stator modules 32 may also be connected to one another. Alternatively, contrary to the depiction of FIG. 1, it is also conceivable that the second controller 41 is connected to each of the second stator modules 32. The first controller 21 and the second controller 41 are connected with the aid of a communication link and may exchange data.

The first stator surface 14 adjoins the second stator surface 34. In FIG. 1, this is embodied in such a way that the first stator surface 14 and the second stator surface 34 touch each other. However, a gap may also be provided between the first stator surface 14 and the second stator surface 34. This forms a boundary 4 between the first stator surface 14 and the second stator surface 34.

Optionally, the planar drive system 1 further comprises a central controller 2 which is connected to the first controller 21 and may exchange data with the first controller 21 and is connected to the second controller 41 and may exchange data with the second controller 41. Furthermore, a transition region 3 is shown in FIG. 1, which is arranged at a boundary 4 between the first planar drive partial system 11 and the second planar drive partial system 31, and respectively comprises those of the first stator modules 12 which are adjacent to the second planar drive partial system 31 and respectively comprises those of the second stator modules 32 which are adjacent to the first planar drive partial system 11. The boundary 4 in FIG. 1 is shown as a straight line. However, the boundary 4 does not have to run in a straight line, but may have any desired course.

It may be intended that the rotor 100, as shown in FIG. 1, floats above the first stator surface 14 or above the second stator surface 34. This may be achieved, for example, by operating the first drive elements 15 or the second drive elements 35, in particular with the aid of magnetic fields generated by the first drive elements 15 or by the second drive elements 35. As an alternative, it may be provided that the first drive elements 15 or the second drive elements 35 only cause a movement parallel to the first stator surface 14 or the second stator surface 34 and the rotor 100 is held above the first stator surface 14 or the second stator surface 34, for example with the aid of an air cushion or with the aid of brushes or rollers. The rotor 100 may be moved in parallel with regard to the first stator surface 14 or the second stator surface 34 in at least two directions. Furthermore, the rotor 100 may optionally be moved perpendicular with regard to the first stator surface 14 or the second stator surface 34. In addition, it may also be provided that the rotor 100 carries out rotational and tilting movements. If all these options of movement are provided, the rotor 100 may be moved in a total of six dimensions, for example by operating the first drive elements 15 or the second drive elements 35.

Instead of the representation of FIG. 1, it may alternatively be provided that the first planar drive partial system 11 and/or the second planar drive partial system 31 comprise a plurality of partial arrangements of the respective stator modules 12, 32, so that the first stator surface 14 comprises a plurality of arrangements of the first stator modules 12 and/or the second stator surface 34 comprises a plurality of arrangements of the second stator modules 32. The method according to the invention may also be used in these cases.

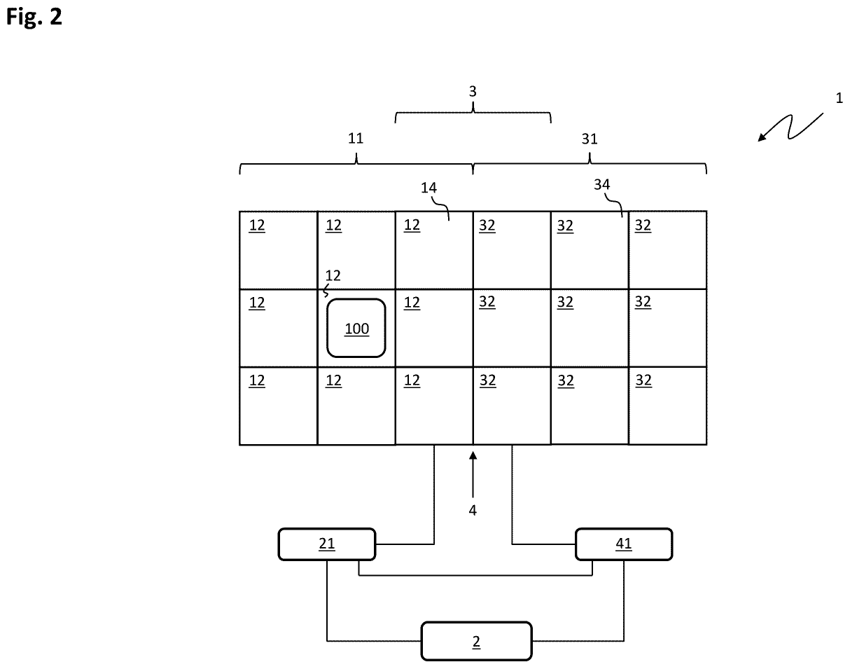

FIG. 2 shows a top view of the planar drive system 1 of FIG. 1. The first planar drive partial system 11 comprises nine first stator modules 12, which are arranged in a 3×3 arrangement. The second planar drive partial system 31 comprises nine second stator modules 32, which are arranged in a 3×3 arrangement. Other arrangements may also be selected. In addition, the number of first stator modules 12 or second stator modules 32 may also be different. Furthermore, the arrangements of the first stator modules 12 of the first planar drive partial system 11 may be different from the arrangements of the second stator modules 32 of the second planar drive partial system 31.

As long as the rotor is arranged outside of the transition area 3, as shown in FIGS. 1 and 2, it may be provided that only the first controller 21 exercises control over the rotor 100. The position of the rotor 100 (rotor position) may then be detected exclusively with the first position detectors 16 in conjunction with the first controller 21. The first drive elements 15 are sufficient for driving the rotor 100. Therefore, no second actuating value is calculated for one of the second drive elements 35, as this is not required for driving the rotor 100.

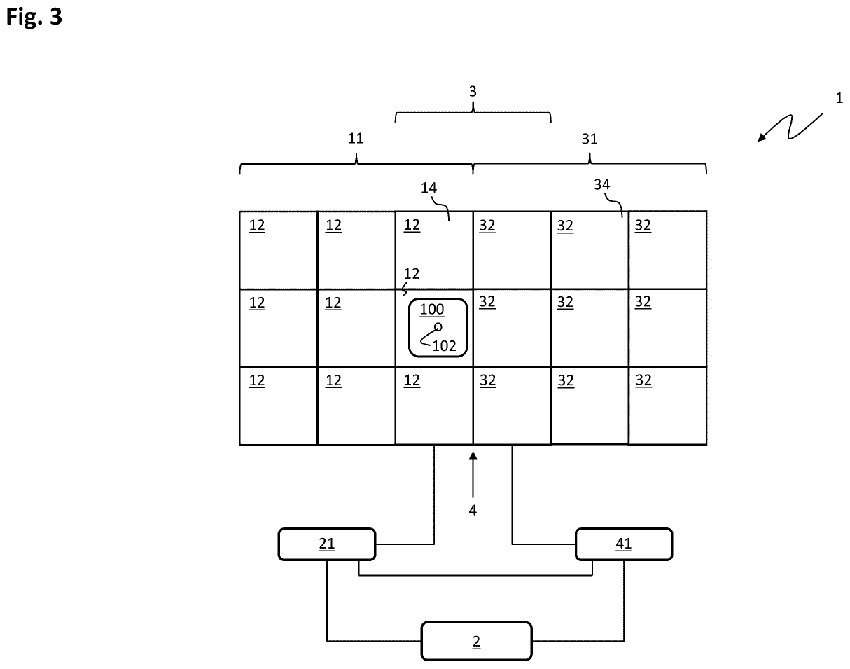

FIG. 3 shows a further top view of the planar drive system 1 of FIGS. 1 and 2. The rotor 100 has been moved in the meantime and is now located in the transition area 3, but still above the first stator surface 14 of the first planar drive partial system s 11. Depending on a marginal condition, it may be provided that the rotor 100 must now be driven with the aid of a cooperation of the first planar drive partial system 11 and the second planar drive partial system 31. The marginal condition may be, for example, that the rotor 100 is arranged above those first stator modules 12 that are adjacent to the second planar drive partial system 31.

An alternative marginal condition may be that the rotor 100 is located in the transition area 3. As the case may be, in this case the transition area 3 may also be larger or smaller and, for example, comprise more than the first stator modules 12 or second stator modules 32 shown in FIG. 3. In particular, the transition area 3 may be selected so that it is always clear to which transition areas 3 a first stator module 12 or a second stator module 32 belongs. This may apply in particular if dimensions of the rotor 100 parallel to the first stator surface 14 are larger than the part of the first stator surface 14 formed by a first stator module 12. An alternative marginal condition may be that a rotor center point 102 has a predetermined distance from the boundary 4. This may be done by a method for operating the planar drive system 1, which is described below. A further alternative marginal condition may be that at least a second drive element 35 is required to drive the rotor 100 or that at least a second position detector 36 is required to determine the rotor position.

It may be provided that the first planar drive partial system 11 has a normal range outside of the transition range 3. In the normal range, the first controller 21 assumes complete control over the rotor 100 without having to rely on measured values from position detectors or on drive elements from other stator modules that are located outside of the planar drive partial system 11. In the transition area 3, on the other hand, measured values from position detectors and/or drive elements from other stator modules that are outside of the planar drive partial system 11 are used. It may then be considered a marginal condition, for example, that the rotor 100 moves into the transition area 3 and therefore measured values from position detectors and/or drive elements from the other stator modules must be used.

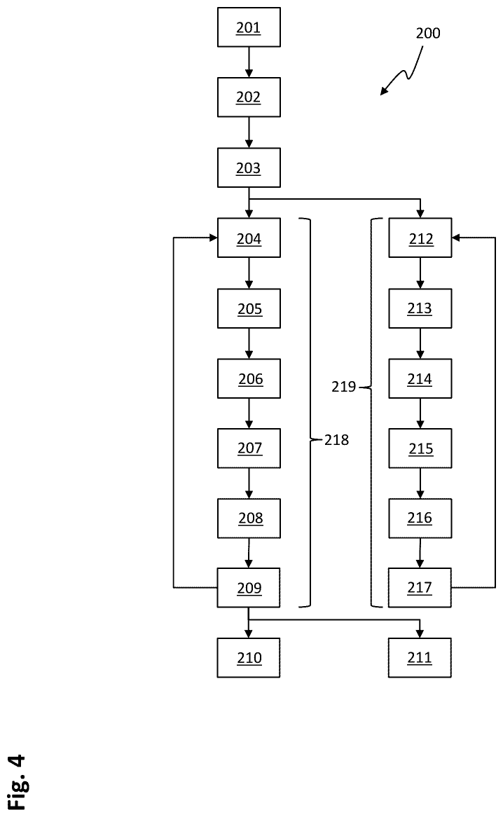

FIG. 4 shows a flow chart 200 of a method for operating the planar drive system 1. The planar drive system 1 may be embodied, for example, as shown in FIGS. 1 to 3.

In a drive cooperating step 201, a drive cooperation is triggered via the first controller 21 on the basis of the marginal condition. In a cooperation signal outputting step 202, a cooperation signal is output from the first controller 21 to the second controller 41. Subsequently, the second controller 41 receives the cooperation signal in a cooperation signal receiving step 203.

In a first measured value outputting step 204, the second measured values of the second position detectors 36 are then output to the first controller 21 via the second controller 41. The first controller 21 receives the second measured values in a first measured value receiving step 205. In a first determining step 206, first rotor position data is determined from the first measured values of the first position detectors 16 and from the second measured values of the second position detectors 36 via the first controller 21.

In a first comparing and calculating step 207, the first rotor position data is compared with first rotor position target data via the first controller 21 and a first actuating value for one of the first drive elements 15 and/or a second actuating value for one of the second drive elements 36 is calculated via the first controller 21 on the basis of the comparison of the first rotor position data with the first rotor position target data. In particular, all first actuating values and second actuating values that are necessary in order to actuate the rotor 100 may be calculated. This may be done by comparing the rotor position data with the known positions of the first drive elements 15 and of the second drive elements 35.

For example, first actuating values may be calculated for all first drive elements 15 and second actuating values for all second drive elements 35 that are covered by the rotor 100. In a first actuating value outputting step 208, the second actuating value is output from the first controller 21 to the second controller 41 if the second actuating value has been calculated and, in particular, is required to actuate the rotor. If the second actuating value has not been calculated because it is not required to actuate the rotor, for example, the second actuating value or the second actuating values are not relevant, in particular with regard to the current rotor position, or do not have to be used or have no influence. The second controller 41 then receives the second actuating value, as the case may be, in a first actuating value receiving step 209. If a plurality of second actuating values have been calculated, all second actuating values are also transmitted from the first controller 21 to the second controller 41.

In a first operating step 210, the first drive element 15 is then operated via the first controller 21 using the first actuating value calculated for the first drive element. In a second operating step 211, the second drive element 35 is operated via the second controller 41 using the second actuating value calculated for the second drive element 35. If more than one first actuating value or second actuating value has been calculated, operation takes place in the first operating step 210 according to all first actuating values and in the second operating step 211 according to all second actuating values. In the following, both variants are not always mentioned at all points, but it may always be assumed that a formulation directed towards a first actuating value or second actuating value should always also include a plurality of first actuating values or second actuating values and vice versa.

The method for operating the planar drive system 1 is based on the idea that the first planar drive partial system 11 and the second planar drive partial system 31 may in principle control the rotor 100 autonomously. However, for certain operating states, for example when a rotor 100 is to be moved in the limit range 3 between the first planar drive partial system 11 and the second planar drive partial system 31, the rotor 100 is driven cooperatively. To make this possible, the first controller 21 is responsible for controlling the rotor 100 in this method. However, the second controller 41 provides the second measured values from the second position detectors 36. This allows the first controller 21 to determine the exact position of the rotor 100, even if the rotor 100 is already at least partially above the second 34 stator surface, for example.

By outputting the second actuating value to the second controller 41, the latter is also able to operate the second drive element 35 in such a way that the rotor 100 may also be driven by the second drive element 35. The second controller 41 therefore does not carry out any control of its own, but operates the second drive elements 35 exclusively according to the received second actuating value or the received second actuating values. If the second actuating values are not required to actuate the rotor 100, for example if the rotor 100 is completely above the first stator surface 14, it may be provided that the second actuating value is nevertheless output via the first controller 21. Furthermore, it may be provided that the first controller 21 outputs corresponding information in this case, on the basis of which the second controller 41 recognizes that the second actuating value is not required to actuate the rotor 100. This may save transmission capacity.

As an alternative, it is possible that the first controller 21 calculates the first actuating value or the first actuating values and the second controller 41 calculates the second actuating value or the second actuating values. In this case, the first controller 21 may then operate the first drive elements 15 with the aid of the first actuating values. The second controller 41 operates the second drive elements 35 with the aid of the second actuating values.

In particular, the first actuating values may be forces that are intended to act upon the rotor 100. The first drive elements 15 may then be operated in such a way that the forces of the first actuating values act upon the rotor 100. Alternatively, the first actuating values may also directly comprise operating information of the first drive elements 15, for example a current for a first drive element 15 embodied as a drive coil or a rotational position or rotational speed for a first drive element 15 embodied as a movable magnet. The second actuating values may also in particular be forces that are to act upon the rotor 100. The second drive elements 35 may then be operated in such a way that the forces of the second actuating values act upon the rotor 100. Alternatively, the second actuating values may also directly comprise operating information of the second drive elements 35, for example a current for a second drive element 35 embodied as a drive coil or a rotational position or rotational speed for a second drive element 35 embodied as a movable magnet.

The first actuating value or, respectively, the first actuating values and the second actuating value, or, respectively, the second actuating values may be calculated with the aid of a control of the first controller 21. In particular, it may be provided that a resulting force, at least two-dimensional, but possibly also up to six-dimensional, is calculated from a rotor position (actual rotor position) and a desired rotor position. The actual rotor position and the desired rotor position may also be six-dimensional, i.e. contain two dimensions in parallel with regard to the first stator surface 14 or second stator surface 34, one dimension perpendicular with regard to the first stator surface 14 or second stator surface 34, one dimension as a rotation about an axis perpendicular with regard to the first stator surface 14 or second stator surface 34 and two dimensions as tilting about axes parallel with regard to the first stator surface 14 or second stator surface 34.

The first drive elements 15 or second drive elements 35 are then operated in such a way that a force on the rotor drive elements 101 corresponds to the resulting force. This control may be carried out, for example, with the aid of an integral controller. As an alternative to a control via the resulting force, direct position control may also be provided.

Furthermore, FIG. 4 optionally shows that, in an embodiment example, the method may switch back to the first measured value outputting step 204 after the first actuating value receiving step 209 in addition to the execution of the first operating step 210 and the second operating step 211, and thus the first measured value outputting step 204, the first measured value receiving step 205, the first determining step 206, the first comparing and calculating step 207, the first actuating value outputting step 208 and the first actuating value receiving step 209 are cyclically repeated. After each of these repetitions, the first operating step 210 and the second operating step 211 may be carried out.

This cyclic repetition may, for example, be carried out with a predetermined cycle time, wherein the predetermined cycle time is less than one millisecond, in particular less than half a millisecond, and may, for example, be 250 microseconds. With a cycle time in this range, for example, the first controller 21 of the first planar drive partial system 11 may actuate one hundred first stator modules 12 and forty rotors 100 above the first stator surface 14. The second controller 41 of the second planar drive partial system 31 may actuate one hundred second stator modules 32 and forty rotors 100 above the second stator surface 34. Depending on the technical equipment of the first controller 21 and/or second controller 41, the data transmission method or data transmission system used, the embodiment of the planar drive system 1 and other marginal conditions, more or fewer stator modules 12, 32 may of course also be controlled in a planar drive partial system 11, 31 and more or fewer rotors 100 may be actuated in a planar drive partial system 11, 31.

The calculation of the first actuating value or, respectively, of the first actuating values and of the second actuating value or, respectively, of the second actuating values via the first controller 21 results in the first controller 21 controlling a position of the rotor 100. The second controller 41 essentially works as a command receiver and operates the second drive elements 35 exclusively with the second actuating values transmitted via the first controller 21.

Optionally, FIG. 4 also shows that in an embodiment example of the method, after the cooperation signal receiving step 203, a second measured value outputting step 212 may be carried out in parallel, in which an output of the first measured values of the first position detectors 16 from the first controller 21 to the second controller 41 takes place. In a second measured value receiving step 213, the second controller 41 receives the first measured values. Subsequently, in a second determining step 214, second rotor position data is determined from the second measured values and from the first measured values via the second controller 41.

In a second comparing and calculating step 215, the second rotor position data is compared with second rotor position target data via the second controller 41 and a calculation of a first redundant actuating value for one of the first drive elements 15 and/or a calculation of a second redundant actuating value for one of the second drive elements 35 via the second controller 41. In a second actuating value outputting step 216, the first redundant actuating value is output via the second controller 41 to the first controller 21. In a second actuating value receiving step 217, the first redundant actuating value is received via the first controller 21. As the case may be, the second measured value outputting step 212, the second measured value receiving step 213, the second determining step 214, the second comparing and calculating step 215, the second actuating value outputting step 216 and the second actuating value receiving step 217 may also be repeated cyclically in this context.

The additional calculation of the first redundant actuating value or, respectively, of the first redundant actuating values and the second redundant actuating values or, respectively, of the second redundant actuating values allows for the second controller 41 to take control of the rotor 100 at any time. In particular, this method may have the consequence that a controller of the second controller 41 is already equipped with all the current control state variables, in particular control parameters, required for control, so that a transfer of control between the first controller 21 and the second controller 41 does not fail because the second controller 41 does not comprise all the control parameters available. This enables safe operation of the planar drive system 1.

In particular, it may be provided that the desired rotor position data is transmitted from the central controller 2 to the first controller 21 or the second controller 41, respectively.

Alternatively, it may be provided that the desired rotor position data is transmitted from the first controller 21 to the second controller 41.

As the case may be, the second operating step 211 may also be carried out using the redundant second actuating value determined in the second comparing and calculating step 215.

For the embodiments of the method for operating the planar drive system 1 described in the following, the first measured value outputting step 204, the first measured value receiving step 205, the first determining step 206, the first comparing and calculating step 207, the first actuating value outputting step 208 and the first actuating value receiving step 209 may be used as the first position control sequence 218 and the second measured value outputting step 212, the second measured value receiving step 213, the second determining step 214, the second comparing and calculating step 215, the second actuating value outputting step 216 and the second actuating value receiving step 217 are designated and summarized as the second position control sequence 219.

A method of operating the first controller 21 may comprise the following steps:
triggering a drive cooperation based on a marginal condition in drive cooperating step 201;
outputting a cooperation signal to a second controller in the cooperation signal outputting step 202;
receiving the second measured values from the second controller in the first measured value receiving step 205;
determining first rotor position data from the first measured values of the first position detectors 16 and the second measured values in the first determining step 206;
comparing the first rotor position data with first rotor position target data and calculating a first actuating value for one of the first drive elements 15 and/or calculating a second actuating value for one of the second drive elements 35 based on the comparison of the first rotor position data with the first rotor position target data in the first comparing and calculating step 207;
outputting the second actuating value to the second controller 41 if the second actuating value was calculated in the first actuating value outputting step 208; and
operating the first drive element 15 with the aid of the first actuating value calculated for the first drive element 15 in the first operating step 210.

In this context, too, it may be provided that the first measured value receiving step 205, the first determining step 206, the first comparing and calculating step 207 and the first actuating value outputting step 208 are repeated cyclically. Furthermore, it may be provided that the second measured value outputting step 212 and the second actuating value receiving step 217 are also executed via the first controller 21. After each of the cyclic repetitions, the first operating step 210 takes place.

A method of operating the second controller 41 comprises the following steps:
receiving a cooperation signal in cooperation signal receiving step 203;
outputting the second measured values of the second position detectors 36 to the first controller in the first measured value outputting step 204;
receiving the second actuating value in the first actuating value receiving step 208; and
operating the second drive element 35 with the aid of the second actuating value calculated for the second drive element 35 via the second controller 41 in the second operating step 211.

In this context, too, it may be provided that the first measured value outputting step 204 and the first actuating value receiving step 208 are repeated cyclically. Furthermore, the method may additionally comprise the second measured value receiving step 213, the second determining step 214, the second comparing and calculating step 215 and the second actuating value outputting step 216. After each of the cyclic repetitions, the second operating step 211 takes place.

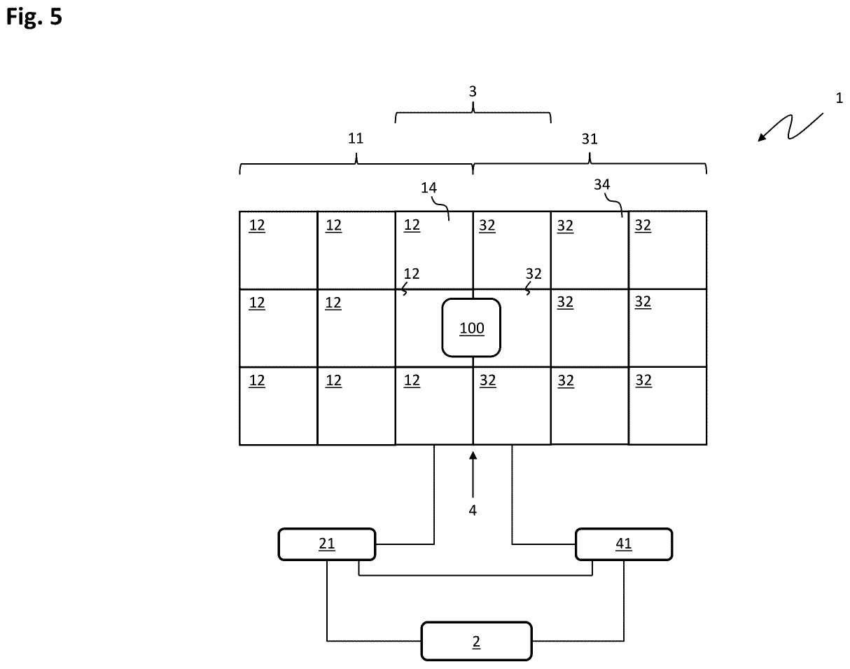

FIG. 5 shows a further top view of the planar drive system 1 of FIGS. 1 to 3. The rotor 100 is partially moved over the boundary 4, so that the rotor 100 is arranged at least partially above the second stator surface 34. In this position, it may further be provided that control over the rotor 100 is exercised via the first controller 21. The second controller 41 merely provides the second measured values of the second position detectors 36 and operates the second drive elements 35 on the basis of the second actuating values.

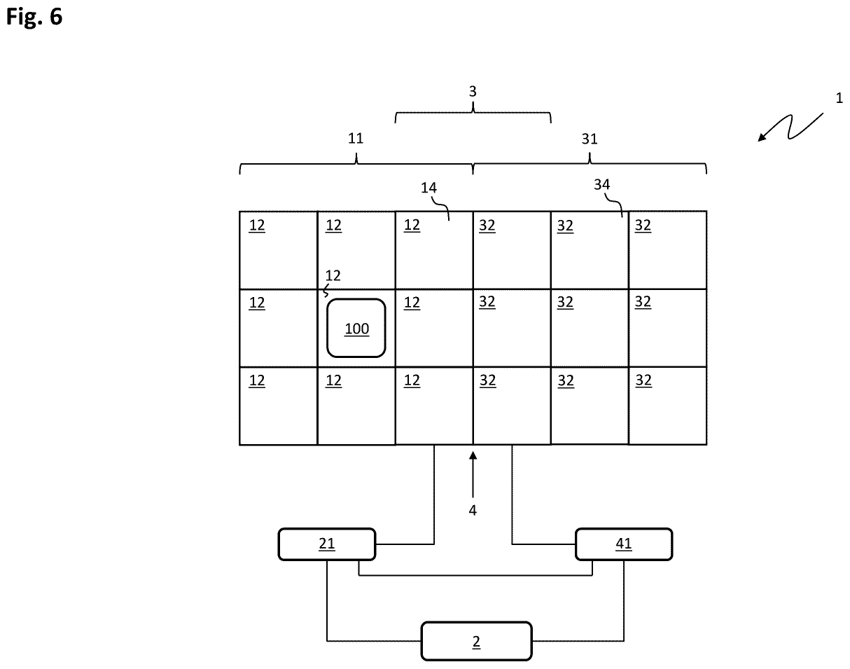

FIG. 6 shows a further top view of the planar drive system 1 of FIGS. 1 to 3 and 5. The rotor 100 has moved back over the first stator surface 14 and is now completely above the first stator surface 14 again. In this case, a transition of the control of the rotor 100 from the first controller 21 to the second controller 41 is not necessary, since a calculation of the first actuating values and of the second actuating values may be carried out via the first controller 21 at all times. If the rotor 100 is again outside of the transition area 3, a termination signal may also be output from the first controller 21 to the second controller 41. As an alternative, it may be provided that the termination signal is already output when the rotor 100 is still in the transition area 3, but it is clear that the rotor 100 is not to be moved back in the direction of the second planar drive partial system 31. After the termination signal has been output, no more measured values from the first position detectors 16 or second position detectors 36 and no more first actuating values for the first drive elements 15 or second actuating values for the second drive elements 35 are exchanged between the first controller 21 and the second controller 41.

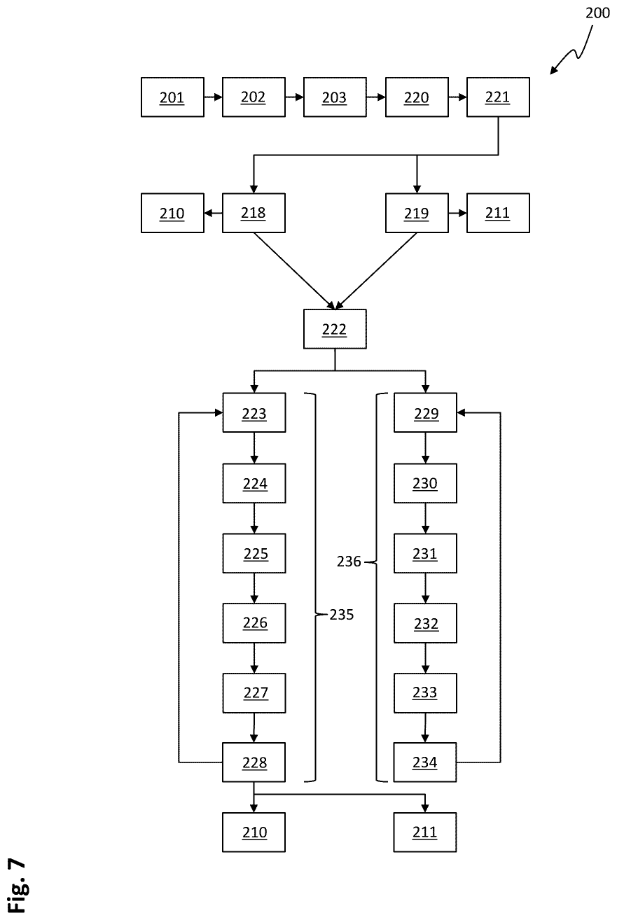

FIG. 7 shows a further flow chart 200 of a method for operating the planar drive system 1, in which steps identical to the method of FIG. 4 are provided with identical reference numerals and optional steps are described below.

In an embodiment example, the cooperation signal is a transfer signal. After the transfer signal has been received via the second controller 41 in the cooperation signal receiving step 203, the second controller 41 checks in a verifying step 220 whether a rotor transfer is possible. The rotor transfer may include a transfer of the rotor 100 from the first planar drive partial system 11 to the second planar drive partial system 31. In the event that a rotor transfer is possible, the second controller 41 issues a confirmation to the first controller 21 in an outputting step 221. In the event that a rotor transfer is not possible, an error message is output via the second controller 41 to the first controller 21 in an outputting step 221. In the event of an error message, no rotor transfer takes place. Furthermore, the error message may result in the cooperating drive being terminated, otherwise it may be intended to carry out the first position control sequence 218 and, as the case may be, the second position control sequence 219 as described in connection with FIG. 4.

In an embodiment example, the second controller 41 checks in the verifying step 220 whether a rotor transfer is possible by evaluating a free computing capacity of the second controller 41. This may be done, for example, on the basis of a current CPU utilization and/or memory utilization of the second controller 41. Furthermore, a number of possible rotors 100 may also be specified, for example the number of forty rotors 100 mentioned above. If a further rotor 100 may be checked according to these criteria, the confirmation is output, otherwise the error message is output.

After the first position control sequence 218 and, if applicable, the second position control sequence 219 have been run through, for example also repeated a plurality of times cyclically, a control transition step 222 takes place. The first position control sequence 218 allows for the rotor 100 to be controlled before the control transition step 222. The second position control sequence 219 may be used to supply a controller of the second controller 41 with all the values required to control the rotor 100.

In the control transition step 222, a control transition from the first controller 21 to the second controller 41 may take place. Furthermore, a rotor transition takes place from the first planar drive partial system 11 to the second planar drive partial system 31. It is not absolutely necessary for the rotor transition and the control transition to take place simultaneously. As the case may be, the control transition may take place before or after the rotor transition. After the control transition or the control transition step 222, the second controller 41 gains control of the rotor 100 and the steps described below are carried out. In a further first measured value outputting step 223, the first measured values of the first position detectors 16 are output via the first controller 21 to the second controller 41.

The first measured values are received via the second controller 41 in a further first measured value receiving step 224. Subsequently, the second controller 41 determines further first rotor position data from the first measured values and the second measured values in a further first determining step 225. In a further first comparing and calculating step 226, the further first rotor position data is compared with further first rotor position target data via the second controller 41 and a first actuating value for one of the first drive elements 15 and/or a second actuating value for one of the second drive elements 35 is calculated via the second controller 41.

In a further first actuating value outputting step 227, the first actuating value is then output via the second controller 41 to the first controller 21 if the first actuating value has been calculated. In a further first actuating value receiving step 228, the first actuating value is received via the first controller 21. The first operating step 210 described above and the second operating step 211 described above then take place. In this context, too, a plurality of first actuating values may be calculated and output and a plurality of second actuating values may be calculated and used.

Furthermore, FIG. 7 optionally shows that in an embodiment example of the method, after the further first actuating value receiving step 228, it is possible to switch back to the further first measured value outputting step 223 and thereby cyclically repeat the further first measured value outputting step 223, the further first measured value receiving step 224, the further first determining step 225, the further first comparing and calculating step 226, the further first actuating value outputting step 227 and the further first actuating value receiving step 228. After each of these repetitions, the first operating step 210 and the second operating step 211 may be executed. This cyclic repetition may, for example, be carried out with a predetermined cycle time, wherein the predetermined cycle time is less than one millisecond, in particular less than half a millisecond, and may, for example, be 250 microseconds.

Optionally, FIG. 7 also shows that in an embodiment example of the method, after the control transition step 222, a further second measured value outputting step 229 may be carried out in parallel, in which an output of the second measured values of the second position detectors 36 from the second controller 41 to the first controller 21 takes place. In a further second measured value receiving step 230, the first controller 21 receives the second measured values. Subsequently, in a further second determining step 231, further second rotor position data is determined from the second measured values and the first measured values via the first controller 21.

In a further second comparing and calculating step 232, a comparison of the further second determined rotor position data with further second rotor position target data is carried out via the first controller 21 and a calculation of a further first redundant actuating value for one of the first drive elements 15 and/or a calculation of a further second redundant actuating value for one of the second drive elements 35 via the first controller 21. In a further second actuating value outputting step 233, the further second redundant actuating value is output via the first controller 21 to the second controller 41.

In a further second actuating value receiving step 234, the further second redundant actuating value is received via the second controller 41. As the case may be, the further second measured value outputting step 229, the further second measured value receiving step 230, the further second determining step 231, the further second comparing and calculating step 232, the further second actuating value outputting step 233 and the further second actuating value receiving step 234 may also be repeated cyclically here. As the case may be, the first operating step 210 may also be performed using the redundant first actuating value determined in the further second comparing and calculating step 232. Here too, a plurality of further first redundant actuating values and a plurality of further second redundant actuating values may be calculated and used.

The additional calculation of the further first redundant actuating variable or, respectively, of the further first redundant actuating variables and the further second redundant actuating variable or, respectively, of the further second redundant actuating variables allows for the first controller 21 to take back control of the rotor 100 at any time.

For the embodiments of the method for operating the planar drive system 1 described in the following, the further first measured value outputting step 223, the further first measured value receiving step 224, the further first determining step 225, the further first comparing and calculating step 226, the further first actuating value outputting step 227 and the further first actuating value receiving step 228 may be used as the further first position control sequence 235 and the second measured value outputting step 229, the further second measured value receiving step 230, the further second determining step 231, the further second comparing and calculating step 232, the further second actuating value outputting step 233 and the further second actuating value receiving step 234 are designated and summarized as further second position control sequence 236.

A control system as described in connection with FIG. 4 may also be provided in the method of FIG. 7. In particular, because the second controller 41 already calculates the first redundant actuating values and the second redundant actuating values before the control transition, regulation may be taken over quickly via the second controller 41 without latencies occurring in which a controller of the second controller 41 is not yet ready.

The control transition of the control transition step 222 may also take place in an interpolated manner over a plurality of cycles. In this case, the actuating values of both the first controller 21 and of the second controller 41 are used for a certain time or over a certain position range. For example, linear interpolation could take place from a complete use of the actuating values of the first controller 21 to a complete use of the actuating values of the second controller 41. Both the first controller 21 and the second controller 41 interpolate the actuating values used. Ideally, this may lead to certain state variables in the receiving control system being set slowly, for which only a parallel calculation before the switchover would not be sufficient.

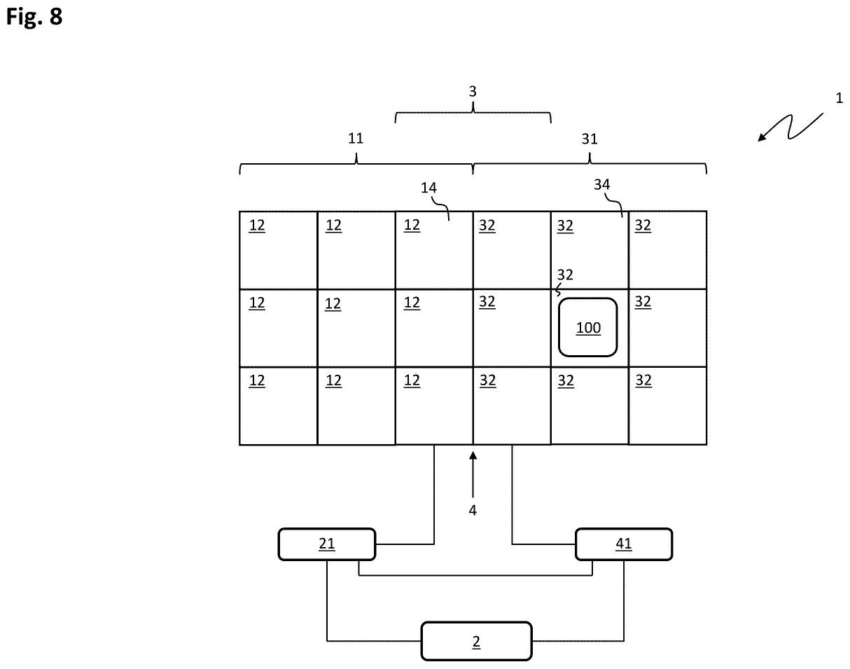

FIG. 8 shows a further top view of the planar drive system 1 of FIGS. 1 to 3, 5 and 6. The rotor 100 is moved via the second planar drive partial system 31. The second controller 41 has taken control of the rotor 100 after the control transition step 222 described in connection with FIG. 7 and is used to calculate the further first actuating values or, respectively, the further second actuating values, while the first controller 21 calculates further first redundant actuating values or, respectively, further second redundant actuating values, as the case may be. If the rotor 100 is again outside of the transition area 3 of the second stator surface 34, a termination signal may also be output from the second controller 41 to the first controller 21.

After the termination signal has been output, no more measured values from the first position detectors 16 or, respectively, from the second position detectors 36 and no further first actuating values for the first drive elements 15 or, respectively, further second actuating values for the second drive elements 35 are exchanged between the first controller 21 and the second controller 41. As an alternative, it may be provided that the termination signal is already output via the second controller 41, for example, when neither measured values from the first position detectors 16 nor operation of the first drive elements 15 are any longer required for controlling the rotor 100.

In an embodiment example of the method for operating the planar drive system 1, rotor-specific data are transmitted between the first controller 21 and the second controller 41. The rotor-specific data may e.g. include a rotor identification number, a mass, a load and/or information about objects arranged on the rotor 100. The rotor-specific data may further include a designation for the rotor 100 and/or specific control settings to be used for the rotor 100. In particular, the rotor identification number may be used to keep track of the individual rotors 100.

Various possibilities are conceivable that lead to the first controller 21 executing the cooperation signal outputting step 202. For example, the first controller 21 may know that all rotors 100 above the first stator surface 14 are to be transferred to the second planar drive partial system 31, for example after processing above the first stator surface 14. In this case, a transfer signal may be output in each case. The second controller 41 then checks whether a rotor 100 may be accepted and the rotor transfer is carried out.

A further option is the central controller 2 shown in FIGS. 1 to 3, 5, 6 and 8. In particular, the central controller 2 may monitor the rotor positions of all rotors 100 of the planar drive system 1 and also specify target positions for all rotors 100. Furthermore, it may be provided that the central controller 2 specifies when the first controller 21 should trigger a drive cooperation with the second controller 41. The first drive elements 15 are then explicitly actuated via the first controller 21, while the second drive elements 35 are controlled via the second controller 41.

In an embodiment, the central controller 2 receives first rotor position data from the first controller 21 and second rotor position data from the second controller 41. The central controller 2 issues a cooperation command to the first controller 21, the cooperation command representing a marginal condition. Based on the cooperation command, the first controller 21 then executes the drive cooperating step 201. Subsequently, the first controller 21 and the second controller 41 carry out the further method steps described in connection with FIGS. 4 and 7.

In an embodiment example, the central controller 2 inquires from the second controller 41 whether a rotor transfer is possible. The second controller 41 checks whether a rotor transfer is possible, for example using the methods already described above. If a rotor transfer is possible, a confirmation is sent to the central controller 2. If a rotor transfer is not possible, an error message is sent to the central controller 2. In the event of confirmation, the central controller 2 may then initiate the rotor transfer by transmitting a corresponding cooperation command to the first controller 21. In this case, it may be provided that the first controller 21 in particular does not carry out the verifying step 220. Alternatively, the central controller 2 may also know from the rotor positions whether a rotor transfer is possible for the second controller 41.

In an embodiment, the central controller 2 uses the first rotor position data and the second rotor position data to recognize that the rotor transfer is complete and outputs a termination signal to the first controller 21 and/or the second controller 41. This allows the central controller 2 to terminate the drive cooperation.

In an embodiment example, the central controller 2 issues a control transfer command to the first controller 21 and/or to the second controller 41. A control transition is carried out on the basis of the control transfer command. In this way, the central controller 2 may control the time of the control transition.

In an embodiment example, the central controller 2 outputs first rotor position target data to the first controller 21 and/or second rotor position target data to the second controller 41. This may be used, for example, if the central controller 2 is to specify the positions of the rotors 100 and the actual actuation of the first drive elements 15 is to be carried out via the first controller 21 or of the second drive elements 35 via the second controller 41, respectively. Furthermore, the method described in connection with FIGS. 4 and 7 may be used to carry out a control transition of a rotor 100 between the first controller 21 and the second controller 41 if this is required by the first rotor position target data or second rotor position target data.

If the central controller 2 is present, it may particularly be provided that the central controller 2 outputs target values for the rotor positions to the first controller 21 or the second controller 41. This output may be cyclical, but a cycle duration may be longer than the cycle time described for the first position control sequence 218 or for the second position control sequence 219 or for the further first position control sequence 235 or for the further second position control sequence 236, respectively, and may be in the range of a few milliseconds to twenty milliseconds, for example two to four milliseconds.

The central controller 2 may specify target values for rotor positions of more rotors 100 than the first controller 21 and the second controller 41 control in each case, since the rotor target positions require significantly less memory capacity than the data required for the explicit control with regard to the measured values of the first position detectors 16 or the second position detectors 36 or with regard to the first actuating values or with regard to the second actuating values. As an alternative, it may be provided that the central controller 2 operates with a cycle time identical to the controllers 21, 41. In this case, a more precise specification of desired rotor positions may be made, which do not have to be interpolated by the controllers 21, 41.

Moreover, independent of this cycle, the central controller 2 may output parameters or rotor-specific information or system-specific information and/or the cooperation command and/or the transfer of control command and/or the scheduling command. The first controller 21 or the second controller 41 cyclically output the first rotor positions or the second rotor positions to the central controller 2 and, outside of the cycle, receive parameters or rotor-specific information or system-specific information or the cooperation command or the transfer-of-control command, as the case may be. In addition, the first controller 21 cyclically executes the first position control sequence 218 or the further second position control sequence 236, as the case may be, and the second controller 41 executes the second position control sequence 219 or the further first position control sequence 235 cyclically, as the case may be.

In particular, the central controller 2 may have knowledge of all positions of all rotors 100 and any objects arranged on the rotors 100. Furthermore, the central controller 2 may specify target rotor positions.

In an embodiment example, the drive cooperation is started when a rotor 100 is within a predetermined distance of an edge area of the first planar drive partial system 11. This may include, for example, the distance to the boundary 4. In particular, it may be provided that the distance corresponds to a dimension of the rotor 100 or of a first stator module 12.

The first controller 21, the second controller 41 and the central controller 2 may each comprise a programmable logic controller with the aid of which the methods may each be carried out. Furthermore, a PLC of the central controller 2 may carry out a user program for determining the desired rotor positions or rotor movements. Furthermore, the first controller 21, the second controller 41 and the central controller 2 may comprise a computer with the aid of which the respective procedures may be carried out. Furthermore, it may be provided that the first controller 21 is integrated into the central controller 2 or the second controller 41 is integrated into the central controller 2. Alternatively, the central controller 2 may be integrated into the first controller 21 or into the second controller 41, i.e. in particular be arranged in the same housing.

If the rotor 100 is now to be transferred again from the second planar drive partial system 31 to the first planar drive partial system 11, the method shown in FIG. 7 may be repeated, with the second planar drive partial system 31 having the second controller 41 now taking over the objects of the first planar drive partial system 11 and the first controller 11 as described in connection with FIG. 7 and vice versa.

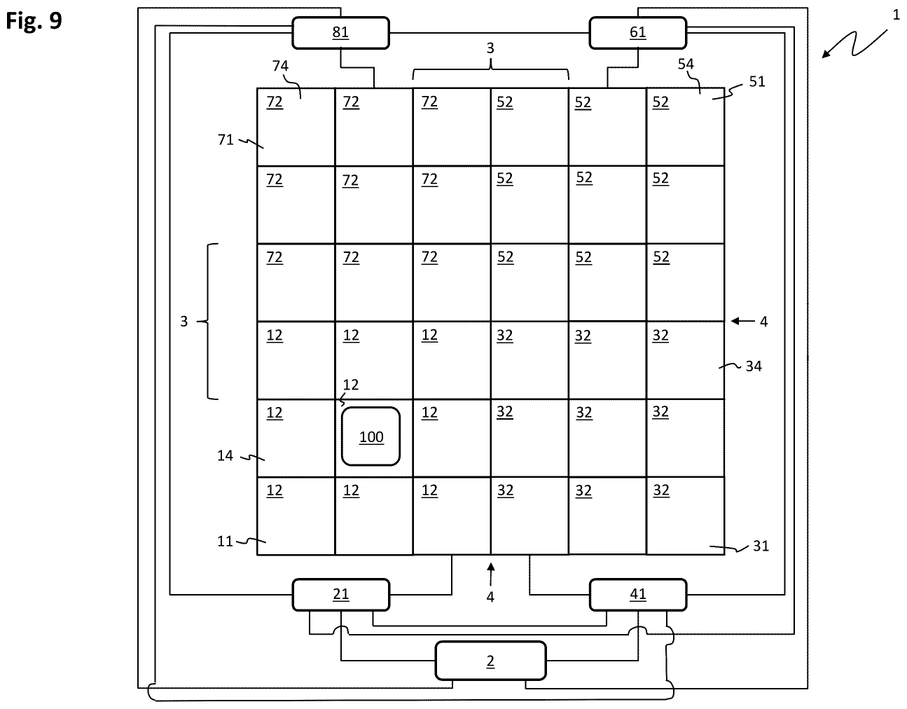

FIG. 9 shows a further planar drive system 1 which corresponds to the planar drive system 1 of FIGS. 1, 2, 3, 5, 6 and 8, unless differences are described below. In addition to the first planar drive partial system 11 and to the second planar drive partial system 31, the planar drive system 1 comprises a third planar drive partial system 51 and a fourth planar drive partial system 71. The third planar drive partial system 51 comprises a third controller 61 and a 3×3 arrangement of third stator modules 52, which form a third stator surface 54. The third controller 61 may be used to operate third drive elements of the third stator modules 52 and to read out third position detectors of the third stator modules 52.

The fourth planar drive partial system 71 comprises a fourth controller 81 and a 3×3 arrangement of fourth stator modules 72 forming a fourth stator surface 74. The fourth controller 81 may be used to operate fourth drive elements of the fourth stator modules 72 and to read out fourth position detectors of the fourth stator modules 72. The third drive elements and the fourth drive elements may be constructed in the same way as the first drive elements 15 and second drive elements 35 already described. The third position detectors and the fourth position detectors may be constructed in the same way as the first position detectors 16 and second position detectors 36 already described.

The first planar drive partial system 11, the second planar drive partial system 31, the third planar drive partial system 51 and the fourth planar drive partial system 71 are adjacent to one another. The first planar drive partial system 11 and the second planar drive partial system 31 are diagonally opposite to each other. The third planar drive partial system 51 and the fourth planar drive partial system 71 are also diagonally opposite to each other. A transition area 3 is formed from three first stator modules 12, three second stator modules 32, three third stator modules 52 and three fourth stator modules 72. In particular, the transition area 3 consists of all the stator modules adjacent to the boundaries 4.

The first controller 21 is directly connected to the second controller 41, the third controller 61 and the fourth controller 81. This allows for communication between all controllers 21, 41, 61, 81. Alternatively, it may be provided that the first controller 21, the second controller 41, the third controller 61 and the fourth controller 81 each comprise only one connection to two adjacent controllers and thus form a ring-shaped connection. It may be provided that communication is possible between all controllers 21, 41, 61, 81 arranged in this annular connection. Furthermore, the third controller 61 is connected to the central controller 2 and the fourth controller 81 is also connected to the central controller 2.

With the method described in connection with FIGS. 1 to 8, the rotor 100 may be transferred from the first planar drive partial system 11 to the second planar drive partial system 31. In order to move from the first planar drive partial system 11 to the second planar drive partial system 31, it may also be provided that parts of the third planar drive partial system 51 and/or parts of the fourth planar drive partial system 71 must be traversed.

It may be provided that in the transition area 3, the first controller 21 first receives measured values of the second position detectors 36 from the second controller 41, measured values of the third position detectors from the third controller 61 and measured values of the fourth position detectors from the fourth controller 81, from which it calculates first actuating values, second actuating values as already described and third actuating values for the third drive elements as well as fourth actuating values for the fourth drive elements and outputs the second actuating values to the second controller 41, the third actuating values to the third controller 61 and the fourth actuating values to the fourth controller 81.

After the control transition has taken place, the second controller 41 may now receive measured values of the first position detectors 16 from the first controller 21, measured values of the third position detectors from the third controller 61 and measured values of the fourth position detectors from the fourth controller 81, from which further first actuating values may be calculated, further second actuating values as already described and further third actuating values for the third drive elements as well as further fourth actuating values for the fourth drive elements and output the further first actuating values to the first controller 21, the further third actuating values to the third controller 61 and the further fourth actuating values to the fourth controller 81.

During the rotor transition, all planar drive partial systems 11, 31, 51, 71 are thus operated in cooperation, but only the first controller 21 and then the second controller 41 exercise control over the rotor 100. In particular, it may be provided that the third controller 61 provides third measured values and, as the case may be, operates third drive elements using the third actuating values and the fourth controller 81 provides fourth measured values and, as the case may be, operates fourth drive elements using the fourth actuating values, but neither the third controller 61 nor the fourth controller 81 take control of the rotor 100.

The embodiments of the planar drive systems 1 shown are always shown with only one rotor 100 and cooperative driving or a transfer of the rotor 100 from one of the planar drive partial systems 11, 31, 51, 71 to another of the planar drive partial systems 11, 31, 51, 71 may take place using the methods described. Of course, each of the planar drive partial systems 11, 31, 51, 71 may control a plurality of rotors 100. As the case may be, more than one cooperating drive or a plurality of rotor transfers may take place simultaneously, wherein the methods described are used for each rotor 100 concerned.

The planar drive partial systems 11, 31, 51, 71 may be arranged according to the requirements resulting from the application of the planar drive system 1 in automation technology, in particular production technology, handling technology, process technology, packaging technology and printing technology. The marginal condition for the drive cooperation may result from the fact that one of the controllers 21, 41, 61, 81 recognizes that a rotor is moving towards another of the planar drive partial systems 11, 31, 51, 71 and position detectors or drive elements of the respective planar drive partial system 11, 31, 51, 71 are required. In this case, it may be provided that the controllers 21, 41, 61, 81 control the rotors 100 autonomously and no central controller 2 is provided. In this case, it may also be provided that the desired rotor position is determined by one of the controllers 21, 41, 61, 81. As an alternative, the central controller 2 may specify the rotor positions, wherein this may result in a demand for cooperative driving or a rotor transfer and in this case either the central controller 2 or the controllers 21, 41, 61, 81 trigger the cooperative driving or the rotor transfer.

Furthermore, it may be provided that the central controller 2 and/or the controllers 21, 41, 61, 81 are time-synchronized with the central controller 2 and/or the controllers 21, 41, 61, 81 are time-synchronized among one another, for example with distributed clocks. A field bus may be used for communication between the controllers 21, 41, 61, 81 and the central controller 2 and/or between the controllers 21, 41, 61, 81, for example based on Ethernet technology or EtherCAT. Further network elements such as switches, hubs and/or port multipliers may also be arranged between the controllers 21, 41, 61, 81 and, as the case may be, the central controller 2.

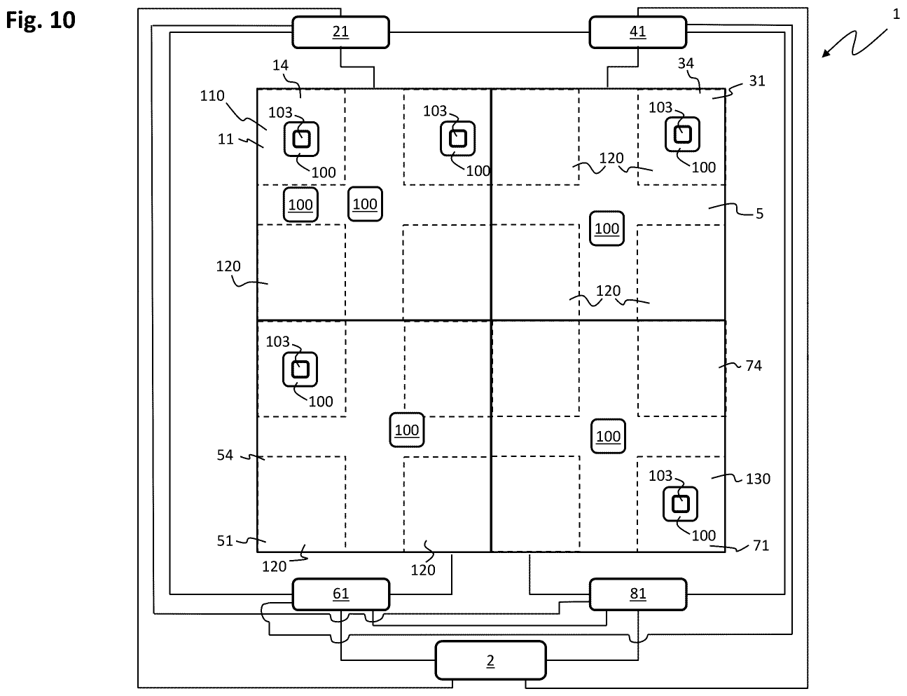

FIG. 10 shows a top view of a further planar drive system 1, which comprises a first planar drive partial system 11, a second planar drive partial system 31, a third planar drive partial system 51 and a fourth planar drive partial system 71. The planar drive partial systems 11, 31, 51, 71 may have the features already described and are arranged in a 2×2 arrangement. In FIG. 10, however, for the sake of clarity, only the first stator surface 14 of the first planar drive partial system 11, the second stator surface 34 of the second planar drive partial system 31, the third stator surface 54 of the third planar drive partial system 51 and the fourth stator surface 74 of the fourth planar drive partial system 71 as well as the first controller 21, the second controller 41, the third controller 61 and the fourth controller 81 as well as the central controller 2 are shown. The drive elements and position detectors may be embodied as already described. Each of the planar drive partial systems 11, 31, 51, 71 may comprise a plurality of corresponding stator modules.

An object transfer station 110 is shown on a common stator surface 5 of the planar drive system 1 formed by the first stator surface 14, the second stator surface 34, the third stator surface 54 and the fourth stator surface 74, at which a rotor 100 may transfer an object 103 from another part of an automation system. A plurality of object processing stations 120 are used to process the objects 103. An object transfer station 130 may be used to transfer the objects back from the rotor 100 to another part of the automation system. The object transfer station 110 and the object transfer station 130 are arranged diagonally opposite to each other on the joint stator surface 5.

The object processing stations 120 are distributed on the joint stator surface 5, and a plurality of object processing stations 120 are even part of a plurality of the planar drive partial systems 11, 31, 51, 71. In the embodiment shown in FIG. 10, it is advantageous if the central controller 2 specifies the positions of the rotors 100, but the exact control of the drive elements of the planar drive partial systems 11, 31, 51, 71 is carried out by the respective controllers 21, 41, 61, 81. In particular, it may be provided that the central controller 2 maintains an overview of all rotor positions and desired rotor positions and passes these on to the corresponding controllers 21, 41, 61, 81. This may be particularly advantageous if the planar drive partial systems 11, 31, 51, 71 are arranged in a 2×2 arrangement as shown in FIG. 10. Furthermore, this configuration also allows for various processing operations to be carried out at the different object processing stations 120, as the case may be, and thus a flexible automation system may be achieved.

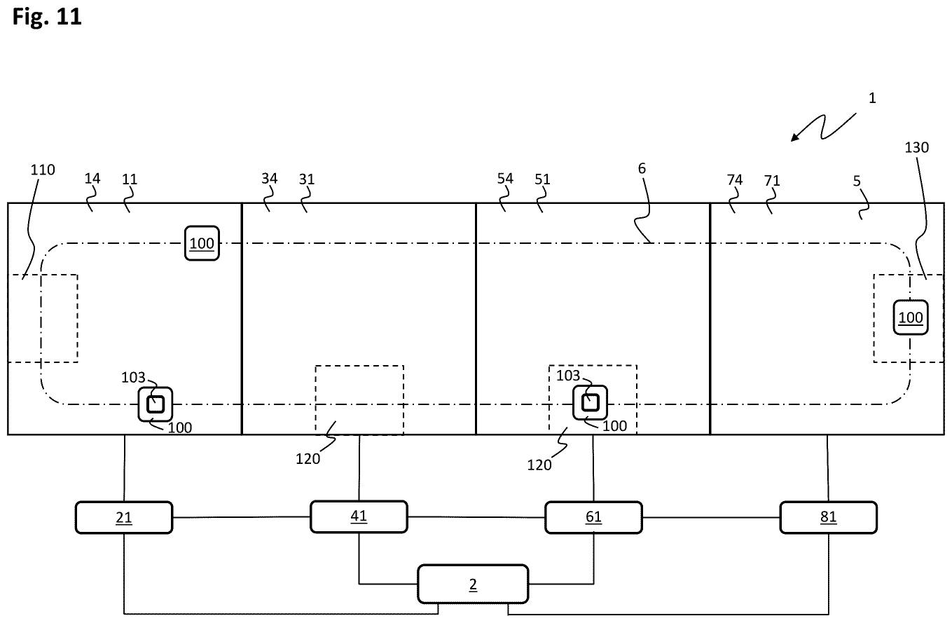

FIG. 11 shows a top view of a further planar drive system 1, which comprises a first planar drive partial system 11, a second planar drive partial system 31, a third planar drive partial system 51 and a fourth planar drive partial system 71. The planar drive partial systems 11, 31, 51, 71 may have the features already described and are arranged linearly one after the other. In particular, the first planar drive partial system 11 is adjacent to the second planar drive partial system 31. The second planar drive partial system 31 is adjacent to the first planar drive partial system 11 and to the third planar drive partial system 51. The third planar drive partial system 51 is adjacent to the second planar drive partial system 31 and to the fourth planar drive partial system 71. The fourth planar drive partial system 71 is adjacent to the third planar drive partial system 51.

In FIG. 11, however, for the sake of clarity, only the first stator surface 14 of the first planar drive partial system 11, the second stator surface 34 of the second planar drive partial system 31, the third stator surface 54 of the third planar drive partial system 51 and the fourth stator surface 74 of the fourth planar drive partial system 71 as well as the first controller 21, the second controller 41, the third controller 61 and the fourth controller 81 as well as the central controller 2 are shown. The drive elements and position detectors may be embodied as already described; each of the planar drive partial systems 11, 31, 51, 71 may comprise a plurality of corresponding stator modules.

On a common stator surface 5 of the planar drive system 1, which is formed by the first stator surface 14, the second stator surface 34, the third stator surface 54 and the fourth stator surface 74, an object transfer station 110 is shown, at which a rotor 100 may transfer an object 103 from another part of an automation system. The object transfer station 110 is arranged above the first stator surface 14. A plurality of object processing stations 120 are used to process the objects 103. One of the object processing stations 120 is arranged above the second stator surface 34. One of the object processing stations 120 is arranged above the third stator surface 54.

An object transfer station 130 may be used to transfer the objects back from the rotor 100 to another part of the automation system. The object transfer station 130 is arranged above the fourth stator surface 74. A predetermined rotor movement path 6 is shown with a dotted line on the common stator surface 5. The rotors 100 follow the predetermined rotor movement path 6, which leads from the object transfer station 110 via the object processing stations 120 to the object transfer station 130 and from there back to the object transfer station 110.

In the embodiment shown in FIG. 11, the central controller 2 may specify the positions of the rotors 100, with the drive elements of the planar drive partial systems 11, 31, 51, 71 then being precisely controlled by the respective controllers 21, 41, 61, 81. In particular, it may be provided that the central controller 2 maintains an overview of all rotor positions and desired rotor positions and passes these on to the corresponding controllers 21, 41, 61, 81. Alternatively, however, the central controller 2 is not absolutely necessary here. Since the predetermined rotor movement path 6 specifies which rotors 100 are to be transferred from which of the planar drive partial systems 11, 31, 51, 71 to which of the planar drive partial systems 11, 31, 51, 71, the controllers 21, 41, 61, 81 may also coordinate corresponding rotor transfers autonomously and carry them out using the method described. This may reduce the complexity of the planar drive system 1.

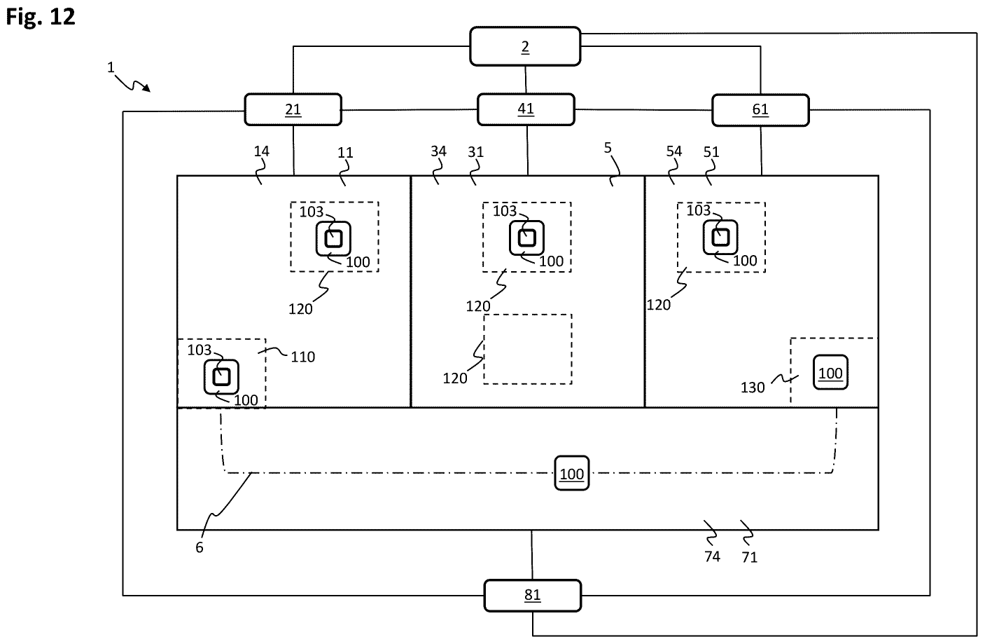

FIG. 12 shows a top view of a further planar drive system 1, which comprises a first planar drive partial system 11, a second planar drive partial system 31, a third planar drive partial system 51 and a fourth planar drive partial system 71. The planar drive partial systems 11, 31, 51, 71 may have the features already described.

The first planar drive partial system 11, the second planar drive partial system 31 and the third planar drive partial system 51 are arranged linearly one after the other. The third planar drive partial system 51 is connected to the first planar drive partial system 11 via the fourth planar drive partial system 71. For the sake of clarity, only the first stator surface 14 of the first planar drive partial system 11, the second stator surface 34 of the second planar drive partial system 31, the third stator surface 54 of the third planar drive partial system 51 and the fourth stator surface 74 of the fourth planar drive partial system 71 as well as the first controller 21, the second controller 41, the third controller 61 and the fourth controller 81 as well as the central controller 2 are shown in FIG. 12.

The drive elements and position detectors may be embodied as already described; each of the planar drive partial systems 11, 31, 51, 71 may comprise a plurality of corresponding stator modules. On a joint stator surface 5 of the planar drive system 1, which is formed by the first stator surface 14, the second stator surface 34, the third stator surface 54 and the fourth stator surface 74, an object transfer station 110 is shown, at which a rotor 100 may transfer an object 103 from another part of an automation system. The object transfer station 110 is arranged above the first stator surface 14. A plurality of object processing stations 120 are used to process the objects 103. One of the object processing stations 120 is arranged above the first stator surface 14. Two object processing stations 120 are arranged above the second stator surface 34 One of the object processing stations 120 is arranged above the third stator surface 54. An object transfer station 130 may be used to transfer the objects back from the rotor 100 to another part of the automation system. The object transfer station 130 is arranged above the third stator surface 54.

Optionally, an object processing station 120, the object transfer station 110 and/or the object transfer station 130 may also be arranged above a plurality of stator surfaces 14, 34, 54, 74 analogous to FIG. 10. A predetermined rotor movement path 6 is shown with a dotted line on the fourth stator surface 74 and connects the object transfer station 130 with the object transfer station 110. The rotors 100 thus follow the predetermined rotor movement path 6 from the object transfer station 130 to the object transfer station 110. This embodiment example of the planar drive system 1 may include that not every rotor 100 approaches each of the object processing stations 120. In particular, for example, it may be intended to omit the object processing stations 120 on the first stator surface 14 and/or the third stator surface 54 and/or, as the case may be, to omit one or more of the object processing stations 120 on the second stator surface 34. Nevertheless, the rotors 100 are always transferred from the first planar drive partial system 11 to the second planar drive partial system 31, from the second planar drive partial system 31 to the third planar drive partial system 51, from the third planar drive partial system 51 to the fourth planar drive partial system 71 and from the fourth planar drive partial system 71 back to the first planar drive partial system 11.

In the embodiment shown in FIG. 12, the central controller 2 may specify the positions of the rotors 100, with the drive elements of the planar drive partial systems 11, 31, 51, 71 then being precisely controlled by the respective controllers 21, 41, 61, 81. In particular, it may be provided that the central controller 2 maintains an overview of all rotor positions and desired rotor positions and passes these on to the corresponding controllers 21, 41, 61, 81. Alternatively, however, the central controller 2 is not absolutely necessary here, either. Since the respective planar drive partial systems 11, 31, 51, 71 involved in rotor transfers are predetermined, i.e. which rotors 100 are to be transferred from which of the planar drive partial systems 11, 31, 51, 71 to which of the planar drive partial systems 11, 31, 51, 71, the controllers 21, 41, 61, 81 may also coordinate corresponding rotor transfers autonomously and carry them out using the method described. This may reduce the complexity of the planar drive system 1.

In addition to the configurations of the planar drive system 1 described in connection with FIGS. 10 to 12, further options are conceivable that use the procedures described in the method according to the invention for drive coordination or for rotor transfer. Overall, this allows for a flexible embodiment of an automation system that uses a planar drive system 1 for transportation. As the case may be, parts of the drive coordination may also be triggered by the central controller 2 and other parts of the drive coordination may be triggered by the controllers 21, 41, 61, 81.

The wording used throughout the description with regard to a single or a plurality of actuating values are interchangeable. If one actuating value is mentioned, a plurality of actuating values may always be provided. If a plurality of actuating variables are mentioned, only one of the corresponding actuating variables may be provided.

This invention has been described with respect to exemplary embodiments. It is understood that changes can be made and equivalents can be substituted to adapt these disclosures to different materials and situations, while remaining with the scope of the invention. The invention is thus not limited to the particular examples that are disclosed, but encompasses all the embodiments that fall within the scope of the claims.

TABLE 1
Figure references 1-130

| | |
|---|---|
| 1 | Planar drive system |
| 2 | Central controller |
| 3 | Transition area |
| 4 | Boundary |
| 5 | Shared stator area |
| 6 | Specified rotor movement path |
| 11 | First planar drive partial system |
| 12 | First stator module |
| 13 | First stator assembly |
| 14 | First stator surface |
| 15 | First drive element |
| 16 | First position detector |
| 21 | First controller |
| 31 | Second planar drive partial system |
| 32 | Second stator module |
| 33 | Second stator assembly |
| 34 | Second stator surface |
| 35 | Second drive element |
| 36 | Second position detector |
| 41 | Second controller |
| 51 | Third planar drive partial system |
| 52 | Third stator module |
| 54 | Third stator surface |
| 61 | Third controller |
| 71 | Fourth planar drive partial system |
| 72 | Fourth stator module |
| 74 | Fourth stator surface |
| 81 | Fourth controller |
| 100 | Rotor |
| 101 | Rotor drive element |
| 102 | Rotor center |
| 103 | Object |
| 110 | Object take-over station |
| 120 | Object processing station |
| 130 | Object transfer station |

TABLE 2
Figure references 200-236

| | |
|---|---|
| 200 | Flow chart |
| 201 | Drive cooperating step |
| 202 | Cooperation signal outputting step |
| 203 | Cooperation signal receiving step |
| 204 | First measured value outputting step |
| 205 | First measured value receiving step |
| 206 | First determining step |
| 207 | First comparing and calculating step |
| 208 | First actuating value outputting step |
| 209 | First actuating value receiving step |
| 210 | First operating step |
| 211 | Second operating step |
| 212 | Second measured value outputting |
| | step |
| 213 | Second measured value receiving |
| | step |
| 214 | Second determining step |
| 215 | Second comparing and calculating |
| | step |
| 216 | Second actuating value outputting |
| | step |
| 217 | Second actuating value receiving step |
| 218 | First position control sequence |
| 219 | Second position control sequence |
| 220 | Verifying step |
| 221 | Outputting step |
| 222 | Control transition step |
| 223 | Further first measured value |
| | outputting step |
| 224 | Further first measured value receiving |
| | step |
| 225 | Further first investigative step |
| 226 | Further first comparing and |
| | calculating step |
| 227 | Further first actuating value |
| | outputting step |
| 228 | Further first actuating value receiving |
| | step |
| 229 | Further second measured value |
| | outputting step |
| 230 | Further second measured value |
| | receiving step |
| 231 | Further second investigation step |
| 232 | Further second comparing and |
| | calculating step |
| 233 | Further second actuating value |
| | outputting step |
| 234 | Further second actuating value |
| | receiving step |
| 235 | Further first position control sequence |
| 236 | Further second position control |
| | sequence |

The invention claimed is:

1. A method for operating a planar drive system, wherein the planar drive system comprises:
a first planar drive partial system, and
a second planar drive partial system;
wherein the first planar drive partial system comprises first stator modules forming a first stator surface, wherein the first stator modules comprise first drive elements and first position detectors,
wherein the first planar drive partial system further comprises a first controller with which the first drive elements are actuatable, wherein the first controller is configured to read in first measured values of the first position detectors,
wherein the second planar drive partial system comprises second stator modules which form a second stator surface, wherein the second stator modules comprise second drive elements and second position detectors,
wherein the second planar drive partial system further comprises a second controller with which the second drive elements are actuatable, wherein the second controller is configured to read in second measured values of the second position detectors,
wherein the first stator surface is adjacent to the second stator surface, and
wherein the planar drive system further comprises at least one rotor which is movable in at least two directions above the first stator surface and the second stator surface,
respectively, with the aid of the first drive elements and the second drive elements;
wherein the method for operating the planar drive system provides for driving the rotor cooperatively with the aid of the first planar drive partial system and the second planar drive partial system, the method comprising the following steps:
triggering a drive cooperation based on a marginal condition via the first controller;
outputting a cooperation signal to the second controller via the first controller;
receiving the cooperation signal via the second controller;
outputting the second measured values to the first controller via the second controller;
receiving the second measured values via the first controller;
determining first rotor position data from the first measured values and the second measured values via the first controller;
comparing the first rotor position data with first rotor position target data and calculating a first actuating value for one of the first drive elements and/or calculating a second actuating value for one of the second drive elements on the basis of the comparison of the first rotor position data with the first rotor position target data via the first controller;
outputting the second actuating value to the second controller via the first controller if the second actuating value has been calculated;
receiving the second actuating value via the second controller;
operating the first drive element with the aid of the first actuating value calculated for the first drive element via the first controller; and
operating the second drive element with the aid of the second actuating value calculated for the second drive element via the second controller.

2. The method according to claim 1, wherein the steps of:
outputting the second measured values to the first controller via the second controller;
receiving the second measured values via the first controller;
determining first rotor position data from the first measured values and the second measured values via the first controller;
comparing the first rotor position data with first rotor position target data and calculating a first actuating value for one of the first drive elements and/or calculating a second actuating value for one of the second drive elements via the first controller;
outputting the second actuating value to the second controller via the first controller if the second actuating value has been calculated;
receiving the second actuating value via the second controller;
operating the first drive element with the aid of the first actuating value calculated for the first drive element via the first controller; and
operating the second drive element with the aid of the second actuating value calculated for the second drive element via the second controller;
are repeated cyclically.

3. The method according to claim 1, further comprising the steps of:
outputting the first measured values to the second controller via the first controller;
receiving the first measured values via the second controller;
determining second rotor position data from the second measured values and the first measured values via the second controller;
comparing the second rotor position data with second rotor position target data and calculating a first redundant actuating value for one of the first drive elements and/or calculating a second redundant actuating value for one of the second drive elements via the second controller;
outputting the first redundant actuating value to the first controller via the second controller; and
receiving the first redundant actuating value via the first controller.

4. The method according to claim 1, wherein:
the cooperation signal is a transfer signal and, after the transfer signal has been received via the second controller, the second controller determines whether a rotor transfer is possible; and
wherein, if said rotor transfer is determined to be possible, a confirmation is output to the first controller and, if said rotor transfer is not determined to be possible, an error message is output to the first controller.

5. The method according to claim 4, wherein the second controller determines whether the rotor transfer is possible by evaluating a free computing capacity of the second controller.

6. The method according to claim 4, wherein:
a rotor transition from the first planar drive partial system to the second planar drive partial system and a control transition from the first controller to the second controller take place, and
wherein the following steps are carried out after the control transition:
outputting the first measured values to the second controller via the first controller;
receiving the first measured values via the second controller;
determining second rotor position data from the first measured values and the second measured values via the second controller;
comparing the second rotor position data with second rotor position target data and calculating a first actuating value for one of the first drive elements and/or calculating a second actuating value for one of the second drive elements via the second controller;
outputting the first actuating value to the first controller via the second controller if the first actuating value has been calculated;
receiving the first actuating value via the first controller;
operating the first drive element with the aid of the first actuating value calculated for the first drive element via the first controller; and
operating the second drive element with the aid of the second actuating value calculated for the second drive element via the second controller.

7. The method according to claim 6, wherein the steps of:
outputting the first measured values to the second controller via the first controller;
receiving the first measured values via the second controller;
determining second rotor position data from the second measured values and the first measured values via the second controller;
comparing the second rotor position data with second rotor position target data and calculating a first actuating value for one of the first drive elements and/or calculating a second actuating value for one of the second drive elements via the second controller;
outputting the first actuating value to the first controller via the second controller if the first actuating value has been calculated;
receiving the first actuating value via the first controller;
operating the first drive element with the aid of the first actuating value calculated for the first drive element via the first controller; and
operating the second drive element with the aid of the second actuating value calculated for the second drive element via the second controller;
are repeated cyclically.

8. The method according to claim 6, further comprising the following steps carried out after the control transition:
outputting the second measured values to the first controller via the second controller;
receiving the second measured values via the first controller;
determining first rotor position data from the first measured values and the second measured values via the first controller;
comparing the first rotor position data with first rotor position target data and calculating a first redundant actuating value for one of the first drive elements and/or calculating a second redundant actuating value for one of the second drive elements via the first controller;
outputting the second redundant actuating value to the second controller via the first controller; and
receiving the second redundant actuating value via the second controller.

9. The method according to according to claim 1, wherein rotor-specific data are transmitted between the first controller and the second controller.

10. The method according to claim 1, wherein the planar drive system further comprises a central controller, wherein:
the central controller receives first rotor position data from the first controller and receives second rotor position data from the second controller; and
wherein the central controller issues a cooperation command to the first controller, wherein the cooperation command represents a marginal condition.

11. The method according to claim 10, wherein:
the central controller queries the second controller as to whether a rotor transfer is possible, wherein the second controller determines whether said rotor transfer is possible; and
wherein a confirmation is output to the central controller if said rotor transfer is determined to be possible, and an error message is output to the central controller if said rotor transfer is not determined to be possible.

12. The method according to claim 10, wherein the central controller recognizes from the first rotor position data and the second rotor position data that the rotor transfer is completed and outputs a termination signal to the first controller and/or the second controller.

13. The method according to claim 10, wherein the central controller issues a control transfer command to the first controller and/or the second controller, and wherein a control transfer is carried out based on the control transfer command.

14. The method according to claim 10, wherein the central controller outputs first rotor position target data to the first controller and/or second rotor position target data to the second controller.

15. The method according to claim 1, wherein the drive cooperation is started when a rotor is within a predetermined distance of an edge region of the first planar drive partial system.

16. A planar drive system, wherein the planar drive system comprises:
a first planar drive partial system, and
a second planar drive partial system;
wherein the first planar drive partial system comprises first stator modules having first stator assemblies forming a first stator surface, wherein the first stator modules comprise first drive elements and first position detectors,
wherein the first planar drive partial system further comprises a first controller,
wherein the second planar drive partial system comprises second stator modules having second stator assemblies forming a second stator surface, wherein the second stator modules comprise second drive elements and second position detectors,
wherein the second planar drive partial system further comprises a second controller,
wherein the first stator surface is adjacent to the second stator surface, and
wherein the planar drive system further comprises at least one rotor which is movable in at least two directions above the first stator surface and the second stator surface, respectively, with the aid of the first drive elements and the second drive elements; and
wherein the method for operating the planar drive system provides for driving the rotor cooperatively with the first planar drive partial system and the second planar drive partial system.

17. A method for operating a planar drive system, wherein the planar drive system comprises:
a first planar drive partial system; and
a second planar drive partial system;
wherein the first planar drive partial system comprises first stator modules forming a first stator surface, wherein the first stator modules comprise first drive elements and first position detectors,
wherein the first planar drive partial system further comprises a first controller with which the first drive elements are actuatable, wherein the first controller is configured to read in first measured values of the first position detectors,
wherein the second planar drive partial system comprises second stator modules which form a second stator surface, wherein the second stator modules comprise second drive elements and second position detectors,
wherein the second planar drive partial system further comprises a second controller with which the second drive elements are actuatable, wherein the second controller is configured to read in second measured values of the second position detectors, and
wherein the first stator surface is adjacent to the second stator surface; and
wherein the planar drive system further comprises at least one rotor which is movable in at least two directions above the first stator surface and the second stator surface, respectively, with the aid of the first drive elements and the second drive elements;
wherein the method for operating the planar drive system provides for driving the rotor cooperatively with the aid of the first planar drive partial system and the second planar drive partial system, the method comprising the following steps:
triggering a drive cooperation based on a marginal condition via the first controller;
outputting a cooperation signal to the second controller via the first controller;
receiving the cooperation signal via the second controller;
executing a first position control procedure and a second position control procedure, wherein the first position control procedure comprises the following steps:
outputting the second measured values to the first controller via the second controller;
receiving the second measured values via the first controller;
determining first rotor position data from the first measured values and the second measured values via the first controller;
comparing the first rotor position data with first rotor position target data and calculating a first actuating value for one of the first drive elements and/or calculating a second actuating value for one of the second drive elements on the basis of the comparison of the first rotor position data with the first rotor position target data via the first controller;
outputting the second actuating value to the second controller via the first controller if the second actuating value has been calculated; and
receiving the second actuating value via the second controller;
wherein the second position control procedure comprises the following steps:
outputting the first measured values to the second controller via the second controller;
receiving the first measured values via the second controller;
determining second rotor position data from the second measured values and the first measured values via the second controller;
comparing the second rotor position data with second rotor position target data and calculating a first redundant actuating value for one of the first drive elements and/or calculating a second redundant actuating value for one of the second drive elements via the second controller;
outputting the first actuating value to the first controller via the second controller;
receiving the first actuating value via the first controller;
operating the first drive element with the aid of the first actuating value calculated for the first drive element via the first controller; and
operating the second drive element with the aid of the second actuating value calculated for the second drive element via the second controller.

18. The method according to claim 17, wherein the steps of:
outputting the second measured values to the first controller via the second controller;
receiving the second measured values via the first controller;
determining first rotor position data from the first measured values and the second measured values via the first controller;
comparing the first rotor position data with first rotor position target data and calculating a first actuating value for one of the first drive elements and/or calculating a second actuating value for one of the second drive elements via the first controller;
outputting the second actuating value to the second controller via the first controller if the second actuating value has been calculated;
receiving the second actuating value via the second controller;
operating the first drive element with the aid of the first actuating value calculated for the first drive element via the first controller; and
operating the second drive element with the aid of the second actuating value calculated for the second drive element via the second controller;
are repeated cyclically.

19. The method according to claim 17, wherein:
the cooperation signal is a transfer signal and, after the transfer signal has been received via the second controller, the second controller determines whether a rotor transfer is possible; and
wherein, if said rotor transfer is determined to be possible, a confirmation is output to the first controller and, if said rotor transfer is not determined to be possible, an error message is output to the first controller.

20. The method according to claim 17, wherein the planar drive system further comprises a central controller, wherein:
the central controller receives first rotor position data from the first controller and receives second rotor position data from the second controller, and
wherein the central controller issues a cooperation command to the first controller, wherein the cooperation command represents a marginal condition.
